(19) United States
(12) Patent Application Publication
(10) Pub. No.: US 2026/0371131 A1
(43) Pub. Date: Nov. 19, 2026

(54) NEIGHBORING CELL BEAM INFORMATION FOR MOBILITY SCENARIOS

(71) Applicant: QUALCOMM Incorporated, San Diego, CA (US)

(72) Inventors: Qiaoyu LI, Beijing (CN); Tao LUO, San Diego, CA (US); Mahmoud TAHERZADEH BOROUJENI, San Diego, CA (US)

(21) Appl. No.: 19/158,782

(22) PCT Filed: May 3, 2023
(86) PCT No.: PCT/CN2023/091941

§ 371 Date: Aug. 21, 2025

(51) Int. Cl. H04W 24/10; H04L 5/00; H04W 72/044; H04W 72/23

(52) U.S. Cl. CPC H04W 24/10; H04L 5/0094; H04L 5/0096; H04W 72/046; H04W 72/23

(57) ABSTRACT

Methods, systems, and devices for wireless communications are described. A user equipment (UE) may be serviced by multiple network entities, which may each be associated with a cell. In some examples, a UE may receive spatial relationship information from a network entity. The spatial relationship information may indicate a first resource pair of the one or more resource pairs that includes a first resource corresponding to a first beam of a first cell and a second resource corresponding to a second beam of a second cell. The UE may receive a first reference signal on the first resource and a second reference signal on the second resource and may perform a channel quality measurement procedure using the first resource and the second resource. The UE may report the results of the procedure to the network entity with reduced overhead based on the spatial relationship information.

### CROSS REFERENCE

The present Application is a 371 national phase filing of International PCT Application No. PCT/CN2023/091941 by L1 et al., entitled “NEIGHBORING CELL BEAM INFORMATION FOR MOBILITY SCENARIOS,” filed May 3, 2023, which is assigned to the assignee hereof, and which is expressly incorporated by reference in its entirety herein.

### FIELD OF TECHNOLOGY

The following relates to wireless communications, including using beam neighboring information for beam prediction.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support using beam neighboring information for beam prediction. For example, the described techniques enable a user equipment (UE) to utilize information about neighboring cells or beams for a beam prediction procedure. A UE may receive spatial relationship information associated with one or more resource pairs from a network entity. The spatial relationship information may indicate a resource pair of a first resource, which corresponds to a first beam of a first cell, and of a second resource, which corresponds to a second beam of a second cell. The UE may receive a first reference signal on the first resource and a second reference signal on the second resource and may perform a measurement procedure using the first and second reference signals. The UE may report the results of the measurement procedure to a network entity with reduced overhead based on the spatial relationship information. In some implementations, the network entity may receive the spatial relationship information (e.g., from a core network). In such implementations, the network entity may receive the first reference signal and the second reference signal and may perform the channel estimation procedure. The network entity may report the results of the procedure to the core network.

A method for wireless communication at a UE is described. The method may include receiving a control message that indicates spatial relationship information associated with one or more resource pairs, the spatial relationship information indicating a first resource pair of the one or more resource pairs that includes a first resource associated with a first cell and a second resource associated with a second cell different from the first cell, where the first resource corresponds to a first beam of the first cell and the second resource corresponds to a second beam of the second cell, receiving one or more reference signals via the first resource, the second resource, or both, based on the control message, and performing a channel quality measurement procedure for the one or more reference signals based on the first resource associated with the first cell and the second resource associated with the second cell.

An apparatus for wireless communication at a UE is described. The apparatus may include a processor, memory coupled with the processor, and instructions stored in the memory. The instructions may be executable by the processor to cause the apparatus to receive a control message that indicates spatial relationship information associated with one or more resource pairs, the spatial relationship information indicating a first resource pair of the one or more resource pairs that includes a first resource associated with a first cell and a second resource associated with a second cell different from the first cell, where the first resource corresponds to a first beam of the first cell and the second resource corresponds to a second beam of the second cell, receive one or more reference signals via the first resource, the second resource, or both, based on the control message, and perform a channel quality measurement procedure for the one or more reference signals based on the first resource associated with the first cell and the second resource associated with the second cell.

Another apparatus for wireless communication at a UE is described. The apparatus may include means for receiving a control message that indicates spatial relationship information associated with one or more resource pairs, the spatial relationship information indicating a first resource pair of the one or more resource pairs that includes a first resource associated with a first cell and a second resource associated with a second cell different from the first cell, where the first resource corresponds to a first beam of the first cell and the second resource corresponds to a second beam of the second cell, means for receiving one or more reference signals via the first resource, the second resource, or both, based on the control message, and means for performing a channel quality measurement procedure for the one or more reference signals based on the first resource associated with the first cell and the second resource associated with the second cell.

A non-transitory computer-readable medium storing code for wireless communication at a UE is described. The code may include instructions executable by a processor to receive a control message that indicates spatial relationship information associated with one or more resource pairs, the spatial relationship information indicating a first resource pair of the one or more resource pairs that includes a first resource associated with a first cell and a second resource associated with a second cell different from the first cell, where the first resource corresponds to a first beam of the first cell and the second resource corresponds to a second beam of the second cell, receive one or more reference signals via the first resource, the second resource, or both, based on the control message, and perform a channel quality measurement procedure for the one or more reference signals based on the first resource associated with the first cell and the second resource associated with the second cell.

In some examples of the method, apparatuses, and non-transitory computer-readable medium described herein, receiving the control message may include operations, features, means, or instructions for receiving a matrix associated with the one or more resource pairs for the channel quality measurement procedure, where the matrix includes a set of elements that indicate a spatial relationship between the first resource and the second resource.

In some examples of the method, apparatuses, and non-transitory computer-readable medium described herein, receiving the control message may include operations, features, means, or instructions for receiving an indication of probability information associated with the first resource pair for the channel quality measurement procedure, the probability information indicating a spatial relationship between the first resource and the second resource.

In some examples of the method, apparatuses, and non-transitory computer-readable medium described herein, receiving the control message may include operations, features, means, or instructions for receiving a radio resource control message that indicates a first set of reference signal resources for the first cell and a second set of reference signal resources for the second cell, where the second set of reference signal resources may be indicated based on a set of identifiers that correspond to one or more of the first set of reference signal resources.

In some examples of the method, apparatuses, and non-transitory computer-readable medium described herein, receiving the control message may include operations, features, means, or instructions for receiving a radio resource control message that indicates a channel state information report setting, where the channel state information report setting indicates the first resource pair based on a set of identifiers that correspond to the first cell and the second cell.

In some examples of the method, apparatuses, and non-transitory computer-readable medium described herein, receiving the control message may include operations, features, means, or instructions for receiving a radio resource control message that indicates a channel state information resource setting or a channel state information prediction resource setting, where the channel state information resource setting or the channel state information prediction resource setting indicates the one or more resource pairs based on a set of identifiers that correspond to a resource set.

In some examples of the method, apparatuses, and non-transitory computer-readable medium described herein, receiving the control message may include operations, features, means, or instructions for receiving a medium access control (MAC) control element (MAC-CE) or downlink control information (DCI) that activates a channel state information resource set or a channel state information report that indicates the one or more resource pairs.

In some examples of the method, apparatuses, and non-transitory computer-readable medium described herein, receiving the control message may include operations, features, means, or instructions for receiving an indication of one or more beam pairs associated with the one or more resource pairs and an indication of probability information corresponding to a first beam pair of the one or more beam pairs, where the first beam pair includes the first beam and the second beam, and where the probability information indicates a spatial relationship between the first beam and the second beam.

In some examples of the method, apparatuses, and non-transitory computer-readable medium described herein, receiving the control message may include operations, features, means, or instructions for receiving an indication of one or more cell pairs associated with the one or more resource pairs and an indication of probability information corresponding to a first cell pair of the one or more cell pairs, where the first cell pair includes the first cell the second cell, and where the probability information indicates a spatial relationship between the first cell and the second cell.

Some examples of the method, apparatuses, and non-transitory computer-readable medium described herein may further include operations, features, means, or instructions for transmitting, based on the channel quality measurement procedure, a report that indicates a first channel quality measurement for the first resource pair and a set of identifiers that corresponds to the first resource pair.

In some examples of the method, apparatuses, and non-transitory computer-readable medium described herein, the report indicates the first channel quality measurement in accordance with a payload size for the report, where the payload size may be indicated via the control message.

In some examples of the method, apparatuses, and non-transitory computer-readable medium described herein, the report indicates a second channel quality measurement for a second resource pair of the one or more resource pairs and a second set of identifiers that corresponds to the second resource pair.

In some examples of the method, apparatuses, and non-transitory computer-readable medium described herein, the report indicates the first channel quality measurement in accordance with a first payload size for the report and the second channel quality measurement in accordance with a second payload size for the report, where the first payload size may be indicated via the control message and the second payload size may be based on the set of identifiers.

Some examples of the method, apparatuses, and non-transitory computer-readable medium described herein may further include operations, features, means, or instructions for performing a channel quality prediction procedure for the one or more reference signals based on a third resource associated with the first cell and a fourth resource associated with the second cell, where the third resource and the fourth resource may be indicated via the control message and may be different from the first resource and the second resource and transmitting, based on the channel quality prediction procedure, a report that indicates a first channel quality prediction for the one or more reference signals.

In some examples of the method, apparatuses, and non-transitory computer-readable medium described herein, the first cell may be a first layer 1/layer 2-triggered mobility (LTM) candidate cell and the second cell may be a second LTM candidate cell, and where the first LTM candidate cell and the second LTM candidate cell may be each associated with a respective serving cell or a respective non-serving cell.

A method for wireless communication at a network entity is described. The method may include transmitting a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell and transmitting one or more reference signals via the first resource, the second resource, or both based on the control message.

An apparatus for wireless communication at a network entity is described.

The apparatus may include a processor, memory coupled with the processor, and instructions stored in the memory. The instructions may be executable by the processor to cause the apparatus to transmit a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell and transmit one or more reference signals via the first resource, the second resource, or both based on the control message.

Another apparatus for wireless communication at a network entity is described. The apparatus may include means for transmitting a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell and means for transmitting one or more reference signals via the first resource, the second resource, or both based on the control message.

A non-transitory computer-readable medium storing code for wireless communication at a network entity is described. The code may include instructions executable by a processor to transmit a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell and transmit one or more reference signals via the first resource, the second resource, or both based on the control message.

In some examples of the method, apparatuses, and non-transitory computer-readable medium described herein, transmitting the control message may include operations, features, means, or instructions for transmitting a matrix associated with the one or more resource pairs for a channel quality measurement procedure, where the matrix includes a set of elements that indicate a spatial relationship between the first resource and the second resource.

In some examples of the method, apparatuses, and non-transitory computer-readable medium described herein, transmitting the control message may include operations, features, means, or instructions for transmitting an indication of probability information associated with the first resource pair for a channel quality measurement procedure, the probability information indicating a spatial relationship between the first resource and the second resource.

In some examples of the method, apparatuses, and non-transitory computer-readable medium described herein, transmitting the control message may include operations, features, means, or instructions for transmitting an indication of one or more beam pairs associated with the one or more resource pairs and an indication of probability information corresponding to a first beam pair of the one or more beam pairs, where the first beam pair includes the first beam and the second beam, and where the probability information indicates a spatial relationship between the first beam and the second beam.

In some examples of the method, apparatuses, and non-transitory computer-readable medium described herein, transmitting the control message may include operations, features, means, or instructions for transmitting an indication of one or more cell pairs associated with the one or more resource pairs and an indication of probability information corresponding to a first cell pair of the one or more cell pairs, where the first cell pair includes the first cell the second cell, and where the probability information indicates a spatial relationship between the first cell and the second cell.

Some examples of the method, apparatuses, and non-transitory computer-readable medium described herein may further include operations, features, means, or instructions for receiving a report that indicates a first channel quality measurement for the first resource pair and a set of identifiers that corresponds to the first resource pair.

In some examples of the method, apparatuses, and non-transitory computer-readable medium described herein, the report indicates a second channel quality measurement for a second resource pair of the one or more resource pairs and a second set of identifiers that corresponds to the second resource pair.

In some examples of the method, apparatuses, and non-transitory computer-readable medium described herein, the first cell may be a first LTM candidate cell and the second cell may be a second LTM candidate cell, and where the first LTM candidate cell and the second LTM candidate cell may be each associated with a respective serving cell or a respective non-serving cell.

A method for wireless communication at a network entity is described. The method may include receiving, from a core network, a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell, receiving one or more reference signals via the first resource, the second resource, or both based on the control message, and performing a channel quality measurement procedure for the one or more reference signals based on the first resource associated with the first cell and the second resource associated with the second cell.

An apparatus for wireless communication at a network entity is described. The apparatus may include a processor, memory coupled with the processor, and instructions stored in the memory. The instructions may be executable by the processor to cause the apparatus to receive, from a core network, a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell, receive one or more reference signals via the first resource, the second resource, or both based on the control message, and perform a channel quality measurement procedure for the one or more reference signals based on the first resource associated with the first cell and the second resource associated with the second cell.

Another apparatus for wireless communication at a network entity is described. The apparatus may include means for receiving, from a core network, a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell, means for receiving one or more reference signals via the first resource, the second resource, or both based on the control message, and means for performing a channel quality measurement procedure for the one or more reference signals based on the first resource associated with the first cell and the second resource associated with the second cell.

A non-transitory computer-readable medium storing code for wireless communication at a network entity is described. The code may include instructions executable by a processor to receive, from a core network, a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell, receive one or more reference signals via the first resource, the second resource, or both based on the control message, and perform a channel quality measurement procedure for the one or more reference signals based on the first resource associated with the first cell and the second resource associated with the second cell.

In some examples of the method, apparatuses, and non-transitory computer-readable medium described herein, transmitting the control message may include operations, features, means, or instructions for transmitting a matrix associated with the one or more resource pairs for the channel quality measurement procedure, where the matrix includes a set of elements that indicate a spatial relationship between the first resource and the second resource.

In some examples of the method, apparatuses, and non-transitory computer-readable medium described herein, transmitting the control message may include operations, features, means, or instructions for transmitting an indication of probability information associated with the first resource pair for the channel quality measurement procedure, the probability information indicating a spatial relationship between the first resource and the second resource.

In some examples of the method, apparatuses, and non-transitory computer-readable medium described herein, transmitting the control message may include operations, features, means, or instructions for transmitting an indication of one or more beam pairs associated with the one or more resource pairs and an indication of probability information corresponding to a first beam pair of the one or more beam pairs, where the first beam pair includes the first beam and the second beam, and where the probability information indicates a spatial relationship between the first beam and the second beam.

In some examples of the method, apparatuses, and non-transitory computer-readable medium described herein, transmitting the control message may include operations, features, means, or instructions for transmitting an indication of one or more cell pairs associated with the one or more resource pairs and an indication of probability information corresponding to a first cell pair of the one or more cell pairs, where the first cell pair includes the first cell the second cell, and where the probability information indicates a spatial relationship between the first cell and the second cell.

Some examples of the method, apparatuses, and non-transitory computer-readable medium described herein may further include operations, features, means, or instructions for transmitting, based on the channel quality measurement procedure, a report that indicates a first channel quality measurement for the first resource pair and a set of identifiers that corresponds to the first resource pair.

In some examples of the method, apparatuses, and non-transitory computer-readable medium described herein, the report indicates a second channel quality measurement for a second resource pair of the one or more resource pairs and a second set of identifiers that corresponds to the second resource pair.

Some examples of the method, apparatuses, and non-transitory computer-readable medium described herein may further include operations, features, means, or instructions for performing a channel quality prediction procedure for the one or more reference signals based on a third resource associated with the first cell and a fourth resource associated with the second cell, where the third resource and the fourth resource may be indicated via the control message and transmitting, based on the channel quality prediction procedure, a report that indicates a first channel quality prediction for the one or more reference signals.

In some examples of the method, apparatuses, and non-transitory computer-readable medium described herein, the first cell may be a first LTM candidate cell and the second cell may be a second LTM candidate cell, and where the first LTM candidate cell and the second LTM candidate cell may be each associated with a respective serving cell or a respective non-serving cell.

### BRIEF DESCRIPTION OF THE DRAWINGS

FIG. 1 shows an example of a wireless communications system that supports using beam neighboring information for beam prediction in accordance with one or more aspects of the present disclosure.

FIG. 2 shows an example of a wireless communications system that supports using beam neighboring information for beam prediction in accordance with one or more aspects of the present disclosure.

FIG. 3 shows an example of a resource relationship that supports using beam neighboring information for beam prediction in accordance with one or more aspects of the present disclosure.

FIG. 4 shows an example of a beam diagram that supports using beam neighboring information for beam prediction in accordance with one or more aspects of the present disclosure.

FIG. 5 shows an example of a process flow that supports using beam neighboring information for beam prediction in accordance with one or more aspects of the present disclosure.

FIGS. 6 and 7 show block diagrams of devices that support using beam neighboring information for beam prediction in accordance with one or more aspects of the present disclosure.

FIG. 8 shows a block diagram of a communications manager that supports using beam neighboring information for beam prediction in accordance with one or more aspects of the present disclosure.

FIG. 9 shows a diagram of a system including a device that supports using beam neighboring information for beam prediction in accordance with one or more aspects of the present disclosure.

FIGS. 10 and 11 show block diagrams of devices that support using beam neighboring information for beam prediction in accordance with one or more aspects of the present disclosure.

FIG. 12 shows a block diagram of a communications manager that supports using beam neighboring information for beam prediction in accordance with one or more aspects of the present disclosure.

FIG. 13 shows a diagram of a system including a device that supports using beam neighboring information for beam prediction in accordance with one or more aspects of the present disclosure.

FIGS. 14 through 19 show flowcharts illustrating methods that support using beam neighboring information for beam prediction in accordance with one or more aspects of the present disclosure.

### DETAILED DESCRIPTION

In some wireless communications systems, a user equipment (UE) may be served by multiple network entities (e.g., base stations), each of which may be associated with a respective cell that supports wireless communications for the UE or other wireless device. As part of wireless communications, the UE may perform channel estimation procedures for one or more cells as the UE moves between and within coverages areas supported by the one or more cells. For example, the UE may perform a channel estimation procedure by measuring one or more reference signals associated with a first cell and one or more reference signals associated with a second cell. The first cell and the second cell may be neighbors (e.g., adjacent in the spatial domain such that respective coverages areas for the first and second cell may partially overlap). In addition, a first beam corresponding to a first resource of the first cell and a second beam corresponding to a second resource of the second cell may be neighboring beams (e.g., may be directed toward regions or coverage areas that at least partially overlap or may be associated with overlapping waveform propagation paths, such that measurements of signals transmitted via the first and second beam are within a threshold measurement of one another). In some cases, the UE may report the results of the channel estimation procedures to a network entity, however, for scenarios in which multiple beams are measured (e.g., if the UE is in a region supported by multiple beams from multiple cells) or if the UE is in a high mobility state such that the UE moves between coverage areas for multiple cells frequently, the quantity of channel estimation procedures performed may increase, which may increase overhead associated with the transmission of the report.

Various aspects of the present disclosure describe techniques for supporting beam neighboring information for beam prediction. The UE may receive spatial relationship information associated with one or more resource pairs, where the spatial relationship information may indicate a first resource pair of the one or more resource pairs that includes a first resource and a second resource. The first resource and the second resource may be associated with a first cell and a second cell, respectively, and additionally may correspond to a first beam of the first cell and a second beam of the second cell, respectively.

The UE may receive a first reference signal on the first resource and a second reference signal on the second resource and may perform a channel quality measurement (e.g., channel estimation) procedure using the first resource and the second resource. The UE may report the results of the procedure to the network entity with less overhead based on the spatial relationship information. In some implementations, a network entity may receive the spatial relationship information (e.g., from a core network). In such implementations, the network entity may receive the first reference signal and the second reference signal and may perform the channel estimation procedure. The network entity may report the results of the procedure to the core network.

Aspects of the disclosure are initially described in the context of wireless communications systems. Aspects of the disclosure are additionally illustrated with reference to resource relationships, beam diagrams, and process flows. Aspects of the disclosure are further illustrated by and described with reference to apparatus diagrams, system diagrams, and flowcharts that relate to using beam neighboring information for beam prediction.

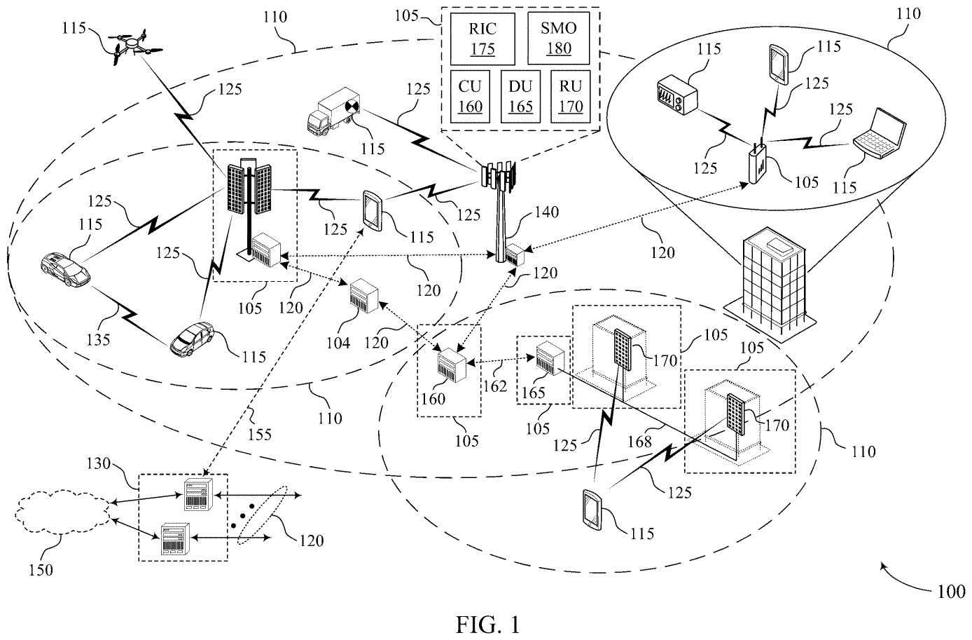

FIG. 1 shows an example of a wireless communications system 100 that supports using beam neighboring information for beam prediction in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125.

The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support using beam neighboring information for beam prediction as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHZ.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas.

Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device.

The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a UE 115 may receive spatial relationship information associated with one or more resource pairs from a network entity 105. The spatial relationship information may indicate a first resource pair of the one or more resource pairs that includes a first resource corresponding to a first beam of the first cell and a second resource corresponding to a second beam of the second cell. The UE may receive a first reference signal on the first resource and a second reference signal on the second resource and may perform a channel quality measurement procedure using the first and second reference signals. The UE 115 may report the results of the procedure to the network entity 105 with less overhead based on the spatial relationship information. In some implementations, the network entity 105 may receive the spatial relationship information (e.g., from a core network 130). In such implementations, the network entity 105 may receive the first reference signal and the second reference signal and may perform the channel estimation procedure. The network entity 105 may report the results of the procedure to the core network 130.

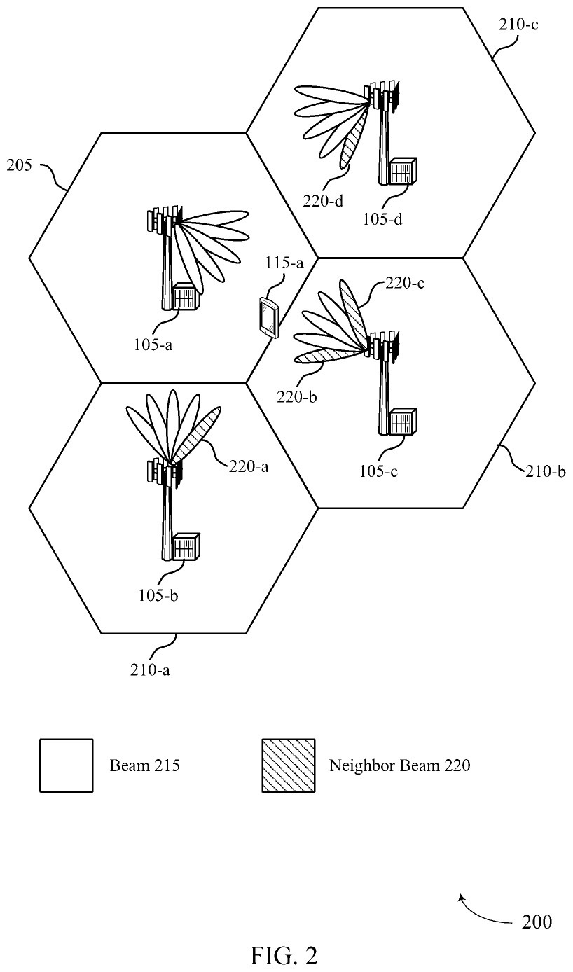

FIG. 2 shows an example of a wireless communications system 200 that supports using beam neighboring information for beam prediction in accordance with one or more aspects of the present disclosure. The wireless communications system 200 may include a UE 115-a and network entities 105, including a first network entity 105-a, a first neighbor network entity 105-b, a second neighbor network entity 105-c, and a third neighbor network entity 105-d, which may be examples of corresponding devices described herein, including with respect to FIG. 1.

The network entities 105 may provide communication coverage to the UE 115-a via respective cells. For example, the first network entity 105-a may be associated with the cell 205, the first neighbor network entity 105-b may be associated with a first neighboring cell 210-a, the second neighbor network entity 105-c may be associated with a second neighboring cell 210-b, and the third neighbor network entity 105-d may be associated with a third neighboring cell 210-c. That is, the cell 205 and the neighboring cells 210 may be neighbors (e.g., adjacent) in the spatial domain and may each support wireless communications over a respective coverage area for the respective network entity 105. The cell 205 and the neighboring cells 210 may be layer-triggered mobility (LTM) candidate cells (e.g., Layer 1 (L1) triggered, Layer 2 (L2) triggered). The cell 205 and the neighboring cells 210 may each be configured as a serving cell (e.g., ServCell) or a non-serving cell for the UE 115-a.

In some examples, the UE 115-a may be in wireless communication with the first network entity 105-a (e.g., when the UE 115-a is located within a coverage area of or served by the cell 205). In such examples, the UE 115-a and the first network entity 105-a may perform channel quality estimation procedures (e.g., a beam measurement procedure, a beam prediction procedure) using one or more beams 215. The one or more beams 215 may be associated with one or more respective resources (e.g., time resources, frequency resources, or both). The UE 115-a may receive one or more reference signals for performing the channel quality estimation procedure on the resources associated with the one or more beams 215. The UE 115-a may report the results of the channel quality estimation procedure to the first network entity 105-a. For example, the UE 115-a may indicate measurements of the reference signals (e.g., L1-reference signal received power (RSRP) measurements, L1 signal-to-interference-plus-noise ratio (SINR) measurements), the resource identifiers (IDs) associated with the reference signals, or any combination thereof, in the report.

In some cases, the UE 115-a may move between the cell 205 and a neighboring cell 210. In such cases, the UE 115-a may perform channel quality estimation procedures with the neighbor network entities 105 associated with the neighboring cells 210 and may report the results (e.g., in an L1 report) of the channel quality estimation procedures to the first network entity 105-a. For example, the UE 115-a may perform a channel quality estimation procedure with the first neighbor network entity 105-b associated with the first neighboring cell 210-a, the second neighbor network entity 105-c associated with the second neighboring cell 210-b, and the third neighbor network entity 105-d associated with the third neighboring cell 210-c.

In such cases, some of the one or more beams 215 associated with the neighboring cells 210 may be neighbor beams 220. A neighbor beam 220 associated with a neighboring cell 210 may be a neighbor to neighbor beam 220 associated with another neighboring cell 210. For example, a field of view (FoV) of a neighbor beam 220-a associated with the first neighboring cell 210-a may overlap with a FoV of a neighbor beam 220-b associated with the second neighboring cell 210-b such that neighbor beam 220-a and neighbor beam 220-b are considered neighbors. Additionally, or alternatively, a FoV of a neighbor beam 220-c associated with the second neighboring cell 210-b may overlap with a FoV of a neighbor beam 220-d associated with the third neighboring cell 210-c such that neighbor beam 220-c and neighbor beam 220-d are considered neighbors. In such cases, the UE 115-a may include channel quality information for multiple neighbor beams 220 in the report, which may result in additional reporting overhead due to the neighboring relationship between some neighbor beams 220 as the channel quality information for such neighbor beams 220 may be similar (e.g., within a quality threshold of one other).

The wireless communications system 200 may support the use of beam neighboring information (shared between the neighbor network entities 105 and the neighboring cells 210) for beam prediction to reduce reporting overhead and improve beam management procedures. The UE 115-a may receive an indication of spatial relationship information (e.g., cross Serv-Cell beam neighboring information) from the first network entity 105-a. In some examples, the first network entity 105-a may indicate the spatial relationship information based at least in part on neighboring information (e.g., relationship information of one or more neighbor beams 220) associated with the neighboring cells 210. The spatial relationship information may indicate an association (e.g., spatial relationship) between neighboring cells 210 or neighbor beams 220, or both. For example, the spatial relationship information may indicate that the first neighboring cell 210-a and the second neighboring cell 210-b are neighbors (e.g., are physically adjacent or otherwise neighboring in the spatial domain).

The spatial relationship information may indicate one or more pairs of resources associated with one or more pairs of neighbor beams 220 to be used for performing a channel quality estimation procedure. For example, one of the one or more pair of resources may include a first resource associated with the first neighboring cell 210-a and the neighbor beam 220-a and a second resource associated with the second neighboring cell 210-b and the neighbor beam 220-b. The resources may be actual resources (e.g., channel measurement resources (CMR), including non-zero-power (NZP)-channel state information (CSI)-reference signal (RS) resources, zero-power (ZP)-CSI-RS resources, CSI-interference measurement (IM) resources, synchronization signal block (SSB) resources, or any combination thereof), or virtual resources (e.g., Type 1, Type 2 virtual resources that are not actually used for transmissions by the UE 115-a or the network entities 105).

In some cases, the first resource may be a first CMR associated with the first neighboring cell 210-a (e.g., CMR #1 in ServCell #1) and the second resource may be a second CMR associated with the second neighboring cell 210-b (e.g., CMR #2 in ServCell #2). In some other cases, the first resource may be a first CMR associated with the first neighboring cell 210-a (e.g., CMR #1 in ServCell #1) and the second resource may be a first virtual resource associated with the second neighboring cell 210-b (e.g., Virtual-Resource in ServCell #2). In yet some other cases, the first resource may be a first virtual resource associated with the first neighboring cell 210-a (e.g., Virtual-Resource in ServCell #1) and the second resource may be a second virtual resource associated with the second neighboring cell 210-b (e.g., Virtual-Resource in ServCell #2).

In some implementations, the first neighboring cell 210-a, the second neighboring cell 210-b, the third neighboring cell 210-c, or any combination thereof, may be the same cell. For example, the first resource and the second resource (e.g., ServCell #1 and ServCell #2) may be the same serving cell for such a configuration to enable intra-serving cell beam neighboring information (e.g., intra-cell spatial relationship information). In such implementations, the one or more resources indicated in the spatial relationship information may be associated with (e.g., defined within) a common cell. For example, the first resource may be a first CMR associated with the first neighboring cell 210-a and the second resource may be a first virtual resource associated with the first neighboring cell 210-a. The UE 115-a may identify resources to be addressed in the report based on receiving the spatial relationship information from the first network entity 105-a. Additionally, or alternatively, the UE 115-a may perform a channel quality prediction procedure based on receiving the spatial relationship information from the first network entity 105-a. In some cases, the UE 115-a may predict the channel characteristics using the one or more resource pairs indicated in the spatial relationship information. In some other cases, the UE 115-a may predict the channel characteristics using other resources and may use the predicted information to predict or select beams (e.g., uplink beams or downlink beams) to use for communication with one or more of the network entities 105.

In some examples, the UE 115-a may receive the spatial relationship information via control signaling from the first network entity 105-a. For example, the first network entity 105-a may indicate the spatial relationship information to the UE 115-a via RRC signaling (e.g., an RRC configuration). In some cases, the RRC signaling may indicate the spatial relationship information via respective resource configuration information elements (IEs). For example, the RRC may configure the first resource (e.g., an SSB resource, a CSI-RS resource) associated with the first neighboring cell 210-a. In addition, the RRC signaling may include an indication of one or more neighboring resources (e.g., SSB resources, CSI-RS resources) associated with the second neighboring cell 210-b, the third neighboring cell 210-c, or both. For example, the RRC signaling may indicate the second resource associated with the second neighboring cell 210-b by indicating a resource ID and a cell ID (e.g., ServCell-ID+Resource-ID) of the second resource.

In some other cases, the RRC signaling may indicate the spatial relationship information via one or more CSI report settings, resource settings (e.g., CSI resource settings, prediction resource settings) or both. For example, the RRC signaling may indicate that one resource pair of the one or more resource pairs associated with the CSI report are neighboring (e.g., indicate pair-wise beam neighboring) by indicating the resource ID pair and a cell ID pair of the resource pair. Additionally, or alternatively, the RRC signaling may indicate one or more resource sets associated with one or more neighboring cells 210 via resource settings. The RRC signaling may indicate that one or more resource pairs of the one or more resource sets associated with the resource settings are neighboring by indicating the resource ID pair and a cell ID pair of the resource pair.

In some other examples, the UE 115-a may receive the spatial relationship information via a MAC-control element (MAC-CE). For example, the UE 115-a may receive a MAC-CE configuring (e.g., activating) a semi-persistent (SP) CSI resource set. The MAC-CE may indicate a neighboring resource set by indicating the resource ID and the cell ID of the neighboring resource set according to techniques described herein. Additionally, or alternatively, the UE may receive a MAC-CE configuring (e.g., activating) a CSI report (e.g., an SP CSI report), and may indicate a neighboring resource set (e.g., a SP CSI resource set) by indicating the resource ID and the cell ID of the neighboring resource set similarly to methods described herein. Further, the MAC-CE may update the spatial relationship information (e.g., information configured by RRC signaling, information updated by the MAC-CE) by signaling to the UE 115-a to select resources from RRC-preconfigured candidate resources.

In yet some other examples, the UE 115-a may receive the spatial relationship information via downlink control information (DCI). In such examples, DCI may dynamically update the information configured via the RRC signaling. For example, the RRC signaling may configure the UE 115-a to transmit an aperiodic CSI report, and the DCI may trigger the report. The UE 115-a may receive the DCI (e.g., triggering the CSI report) and identify the spatial relationship information. Additionally, or alternatively, the DCI may indicate (e.g., explicitly) to update RRC pre-configured spatial relationship information. For example, the UE 115-a may select RRC pre-configured resources or MAC-CE pre-selected candidate resources indicated via DCI.

Additionally, or alternatively, the first network entity 105-a may receive the spatial relationship information and perform a beam prediction procedure. For example, a core network may indicate the spatial relationship information to the first network entity 105-a via RRC signaling. The first network entity 105-a may receive one or more reference signals based on the one or more pairs resources indicated in the spatial relationship information and may perform a channel estimation procedure using the one or more reference signals. Based on performing the channel estimation procedure, the first network entity 105-a may identify resources to be addressed in a report to the core network. Additionally, or alternatively, the first network entity 105-a may perform a channel quality prediction procedure.

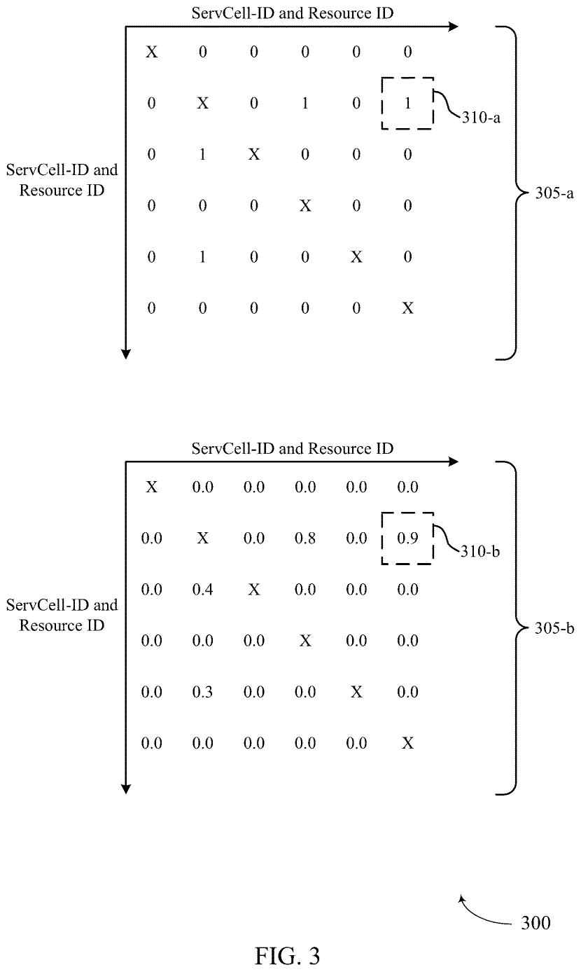

FIG. 3 shows example resource relationships 300 that supports using beam neighboring information for beam prediction in accordance with one or more aspects of the present disclosure. The resource relationships 300 may be implemented by aspects of the wireless communications system 100 and the wireless communications system 200 as described with reference to FIGS. 1 and 2. For instance, in the example of FIG. 3, a UE may receive an indication of spatial relationship information from a network entity, where the UE and the network entity may be examples of corresponding devices described herein, including with reference to FIGS. 1 and 2. For example, the network entity may indicate one or more pairs of resources associated with one or more pairs of beams to be used for performing a channel quality estimation procedure. The network entity may indicate the one or more pairs of resources via a resource neighboring matrix 305-a or a resource neighboring matrix 305-b, for example.

Each pair of the one or more pairs of resources may be associated with a pair of neighboring cells (e.g., ServCell-pair), and each resource of the resource pair may be associated with a respective neighboring cell of the cell pair. The network entity may determine the spatial relationship information based on configuring a quantity of neighboring beam pairs for each cell pair and may configuring the neighboring beam pairs for the cell pairs. In some examples, the network entity may further configure the quantity of neighboring beam pairs with probability information (e.g., probability levels).

In some examples, the network entity may indicate a relationship (e.g., a linkage) between the one or more pairs of resources via the resource neighboring matrix 305-a. The resource neighboring matrix 305-a may indicate hard neighboring information between the one or more pairs of resources using a sparse 0/1 matrix. In such examples, the resource neighboring matrix 305-a may exclude probability information associated with the linkage between the one or more pairs of resources.

Instead, each element of the resource neighboring matrix 305-a may indicate whether a pair of resources are neighbored (e.g., spatially adjacent) to each other. For example, a value of 1 stored in an element 310-a of the resource neighboring matrix 305-a may indicate that a pair of resources associated with transmitting CSI report settings, resource settings, or both, are neighbored to each other. In some cases, the resource neighboring matrix 305-a may exclude the resource pair linkage on the diagonal elements of the resource neighboring matrix 305-a, indicated by ‘X’elements.

In some other examples, the network entity may indicate the linkage between the one or more pairs of resources via the resource neighboring matrix 305-b. The resource neighboring matrix 305-b may indicate soft neighboring information between the one or more pairs of resources. In such examples, the resource neighboring matrix 305-b may include probability information associated with the linkage between the one or more pairs of resources. Each element of the resource neighboring matrix 305-b may indicate whether a pair of resources are resource neighboring matrix 305-b may indicate a probability level (e.g., tight neighboring, loose neighboring) between the pair of resources. For example, a value of 0.9 stored in an element 310-b of the resource neighboring matrix 305-b may indicate that a pair of resources associated with transmitting CSI report settings, resource settings, or both, are tightly neighbored (e.g., spatially adjacent) to each other. Alternatively, a value of 0.9 stored in an element 310-b of the resource neighboring matrix 305-b may indicate that the pair of resources associated with transmitting CSI report settings, resource settings, or both, are loosely neighbored to each other. The probability level may be quantized based on a given quantity of bits. In some cases, the resource neighboring matrix 305-b may exclude the resource pair linkage on the diagonal elements of the resource neighboring matrix 305-b.

The resource neighboring matrices 305 may indicate overall neighboring probability information (e.g., a probability level) associated with one or more pairs of resources (e.g., Cross-ServCell resource-pair). In some examples, the network entity may determine the overall neighboring probability level between one or more pairs of resources based on cell pair-level neighboring probabilities, resource pair-level neighboring probabilities, or both. The cell pair-level neighboring probabilities may indicate relationships between pairs of neighboring cells (e.g., ServCell-pairs). For example, a first cell pair-level neighboring probability may indicate that a first neighboring cell (e.g., ServCell #1) and a second neighboring cell (e.g., ServCell #2) are tightly neighbored (e.g., have a higher neighboring probability value), and a second cell pair-level neighboring probability may indicate that the second neighboring cell (e.g., ServCell #2) and a third neighboring cell (e.g., ServCell #3) are loosely neighbored (e.g., have a lower neighboring probability value).

The resource pair-level neighboring probabilities may indicate relationships between beam pairs associated with neighboring cell pairs. For example, a first resource pair-level neighboring probability may indicate that a first beam associated with the first neighboring cell (e.g., a neighbor beam 220-a associated with the first neighboring cell 210-a described herein with reference to FIG. 2) and a second beam associated with a second neighboring cell (e.g., a neighbor beam 220-b associated with the second neighboring cell 210-b described herein with reference to FIG. 2) are loosely neighbored. A second resource pair-leveling neighboring probability may indicate that a third beam associated with the second neighboring cell (e.g., a neighbor beam 220-c associated with the second neighboring cell 210-b described herein with reference to FIG. 2) and a fourth beam associated with the third neighboring cell (e.g., a neighbor beam 220-d associated with the third neighboring cell 210-c described herein with reference to FIG. 2) are tightly neighbored. As described herein, loosely-neighbored beam pairs may correspond to relatively low resource pair-level neighboring probabilities and tightly-neighbored beam pairs may correspond to relatively high resource pair-level neighboring probabilities.

In such examples, the network entity may prioritize cell pair-level (e.g., ServCell-pair level) neighboring probabilities over resource pair-level neighboring probabilities when determining an overall neighboring probability level. For example, a first overall neighboring probability associated with the first beam and the second beam may be higher (e.g., more tightly neighbored) than a second overall neighboring probability associated with the third beam and the fourth beam (e.g., Prob_ResourceLevel_{{Resource #1@ServCell #1, Resource #2@ServCell #2}}≥Prob ResourceLevel_{{Resource #2@ServCell #1, Resource #3@ServCell #2}}. In such examples, although the third beam and the fourth beam may be more tightly neighbored than the first beam and the second beam, the first neighboring cell (associated with the first beam) may be more tightly neighbored with the second neighboring cell than the third neighboring cell (associated with the fourth beam). That is, while Prob_CellLevel_{{ServCell #1, ServCell #2}}<Prob_CellLevel_{{(ServCell #1, ServCell #2}}, the overall neighboring probability level Prob_Overall_{{Resource #1@ServCell #1, Resource #2@ServCell #2}}<Prob_Overall_{{Resource #2@ServCell #1, Resource #3@ServCell #2}}.

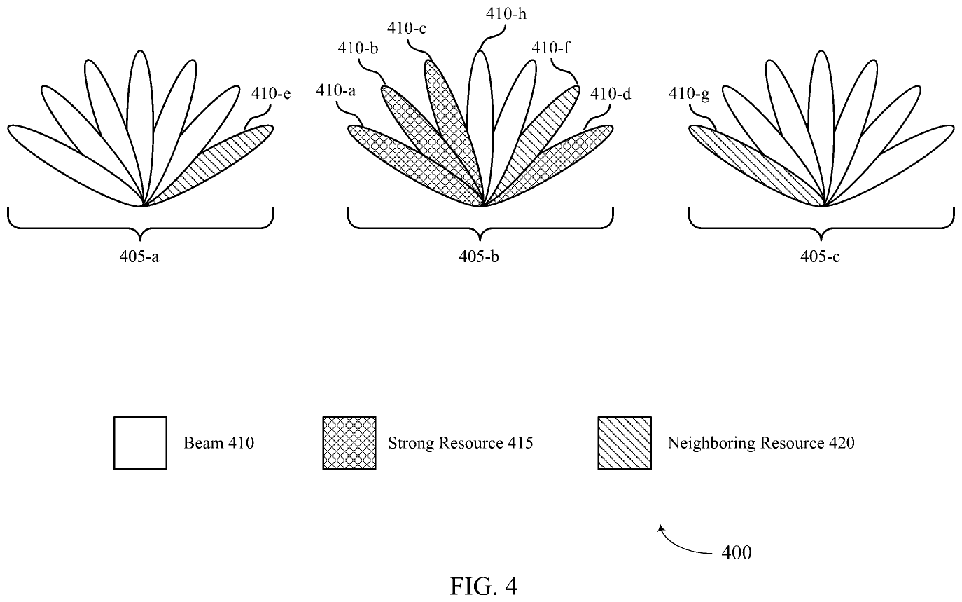

FIG. 4 shows an example of a beam diagram 400 that supports using beam neighboring information for beam prediction in accordance with one or more aspects of the present disclosure. The beam diagram 400 may be implemented by aspects of the wireless communications system 100 and the wireless communications system 200 as described with reference to FIGS. 1 and 2. For instance, a UE may be in communication with multiple neighboring network entities, each of which may be associated with a neighboring cell 405 (e.g., a ServCell). For example, the UE may be in communication with a first neighboring network entity associated with a first neighboring cell 405-a, a second neighboring network entity associated with a second neighboring cell 405-b, and a third neighboring network entity associated with a third neighboring cell 405-c.

Each neighboring cell 405 may be associated with one or more beams 410. The UE may perform a channel quality estimation procedure for one or more reference signals using the one or more beams 410 associated with the first neighboring cell 405-a, the second neighboring cell 405-b, the third neighboring cell 405-c, or any combination thereof, and may report the results of the channel quality estimation procedure (e.g., in an L1 report). In some examples, the L1 report may include an indication of one or more resources associated with the beams 410 and the respective neighboring cells 405 associated with the beams 410. For example, the L1 report may indicate channel characteristics based on the reference signals (e.g., L1-RSRP measurements, L1-SINR measurements, or both), resource IDs associated with the reference signals, or any combination thereof.

In some examples, the UE may identify the one or more resources (e.g., beams 410) to be included (e.g., addressed) in the L1 report. In such examples, the UE may identify a first quantity of resources to be included in the L1 report, which may be strong resources 415. For example, the UE may determine that a first beam 410-aassociated with the second neighboring cell 405-b, a second beam 410-b associated with the second neighboring cell 405-b, a third beam 410-c associated with the second neighboring cell 405-b, and a fourth beam 410-d associated with the second neighboring cell 405-b are associated with strong resources 415. The UE may determine that the first quantity of resources are strong resources 415 based on determining that the beams 410 associated with the strong resources 415 are associated with the strongest channel characteristics (highest L1-RSRP, L1-SINR, or both, or an L1-RSPR or L1-SINR above a threshold). The UE may include (e.g., explicitly indicate) the channel characteristics, a cell ID (e.g., ServCell-ID) associated with the strong resources 415, the resource ID (e.g., resource-ID) associated with the strong resources 415, or any combination thereof, in the L1 report (e.g., via a first payload). The network entity may configure (e.g., preconfigure) the UE with the value of the first quantity of resources via RRC signaling. For example, a CSI report setting configuration associated with the L1 report may configure the UE with the value of the first quantity.

The UE may further identify a second quantity of resources to be addressed in the L1 report, which may be neighboring resources 420. The one or more beams 410 associated with the neighboring resources 420 may neighbor (e.g., spatially) the one or more beams 410 associated with the strong resources 415. For example, the UE may determine that a fifth beam 410-e associated with the first neighboring cell 405-a neighbors (e.g., is spatially adjacent to) the first beam 410-a associated with strong resources 415, a sixth beam 410-f associated with the second neighboring cell 405-b neighbors the fourth beam 410-d associated with strong resources 415, and a seventh beam 410-g associated with the third neighboring cell 405-c neighbors the fourth beam 410-d associated with strong resources 415. The UE may include (e.g., explicitly indicate) the channel characteristics in the L1 report (e.g., via a second payload). In some cases, where a resource of the second quantity of resources is repeated, the UE may include (e.g., represent) the channel characteristics associated with the resource, including L1-RSRP measurements, L1-SINR measurements, or any combination thereof once within the L1 report. In such cases, the UE may determine to exclude additional indications (e.g., presentations) of the channel characteristics as well as cell IDs and resource IDs associated with the channel characteristics In some examples, the UE may order the channel characteristics within the second payload based on a descent strength of the channel characteristics (e.g., L1-RSRP, L1-SINR measurements) associated with the first quantity of resources (e.g., “mother” resources). In some cases, the neighboring resources 420 may be hard neighboring (that is, may have relatively high resource neighboring probability levels). In such cases, the UE may order the channel characteristics within the second payload based on the cell ID associated with the strong resources 415, the resource ID associated with the strong resources 415, or both. In some other cases, the neighboring resources 420 may be soft neighboring. In such cases, the UE may order the channel characteristics first in descending order with respect to the strength of the L1-RSRP and L1-SINR measurements of the first quantity of resources (e.g., “mother resources”), and then according to a descending order of the overall neighboring probability information, which is described herein with reference to FIG. 3. In some other examples, the neighboring resources 420 may be soft neighboring, and the UE may order the channel characteristics within the second payload based on (e.g., directly according to) the overall neighboring probability information in descending order.

In some examples, the UE may transmit the first payload and the second payload included in the L1 report via a 1-part CSI with a fixed payload size. In such examples, the UE may receive signaling configuring the size (e.g., a quantity of entries) of the first payload and the size of the second payload. The signaling may configure the both the first payload and the second payload with a fixed size. For example, the signaling may indicate a quantity of channel characteristics (e.g., a quantity of L1-RSRPs, L1-SINRs, or any combination thereof) to be addressed in the second payload. The signaling may be RRC signaling including a CSI report setting that indicates the quantity of channel characteristics to be addressed in the second payload. Alternatively, the signaling may include a MAC-CE, which may activate an SP CSI report that indicates the quantity of channel characteristics to be addressed in the second payload.

In some cases, the quantity of channel characteristics to be addressed in the second payload may be less than the identified second quantity of resources to be addressed in the L1 report. In such cases, the UE may drop (e.g., cancel) an indication of one or more of the channel characteristic measurements associated with a lower order (e.g., low-priority). For example, the UE may determine that the eighth beam 410-h may neighbor the third beam 410-c associated with strong resources 415. In such cases, the UE may determine to drop the resources associated with an eighth beam 410-h based on determining that the eighth beam 410-h is associated with a lower priority order, the second payload has a limited size, or both. In some other cases, the quantity of channel characteristics to be addressed in the second payload may be greater than the identified second quantity of resources to be addressed in the L1 report. In such cases, the UE may fill the remaining entries of the second payload with L1-RSRP code points, L1-SINR code points, or both. The code points may be reserved or arbitrary, or the UE, the network entities, or any combination thereof may use the code points for other reporting purposes.

Alternatively, the UE may transmit the first payload and the second payload included in the L1 report via a 2-part CSI. In such examples, the size of the first payload (e.g., a first part) may be fixed, and the size of the second payload (e.g., a second part) may be variable. For example, the UE may report the first payload with a first payload size via a first CSI message (e.g., CSI Part 1) based on the received RRC signaling as described herein. The UE may report the second payload with a second payload size via a second CSI message (e.g., CSI Part 2). The UE may determine the second payload size based on the cell ID associated with the strong resources 415, the resource ID associated with the strong resources 415, the identified second quantity of resources, or any combination thereof. In some cases, where the second payload size is smaller than the identified second quantity of resources, the UE may drop one or more resources of the second quantity of resources according to the ordering of the channel characteristic measurements in the L1 report described herein. In some cases, the network entity may configure (e.g., preconfigure) the UE with a threshold value (e.g., an upper limit) for the quantity of second quantity of resources.

In some examples, the channel characteristics included in the second payload may be associated with (e.g., may refer to) the channel characteristics included in the first payload. For example, in some cases, the channel characteristics included in the second payload may differentially refer to the strongest channel characteristics included in the first payload. In some other cases, the channel characteristics included in the second payload may differentially refer to the channel characteristics included in the first payload and associated with the first quantity of resources (e.g., the “mother” resources). A first quantity of bits associated with quantizing the first quantity of resources in the first payload may be different (e.g., larger) than a second quantity of bits associated with quantizing the information in the second payload (e.g., the second quantity of bits may be smaller than the first quantity of bits).

In some implementations, the UE may predict the channel characteristics using the one or more resource pairs indicated in spatial relationship information (e.g., cross-ServCell beam neighboring information provided by a network entity).

Additionally, or alternatively, the UE may predict the channel characteristics using other resources. That is, as the UE may identify resources to be addressed in the L1 report as described herein, the channel characteristics (e.g., L1-RSRP, L1-SINR measurements) the UE reports may be based on the prediction rather than measurements. As such, the target resources (e.g., measured or predicted resources) included in the L1 report may be based on virtual resources, which may not be transmitted by a network entity. Rather, the UE may use the virtual resources for prediction purposes. The UE may determine prediction results based on the received spatial relationship information (e.g., Cross-ServCell beam neighboring information) configured or indicated by a network entity. In addition, the UE may report the results to the network entity. The UE may determine which resources to address in the prediction report using similar techniques described herein with respect to the L1 report.

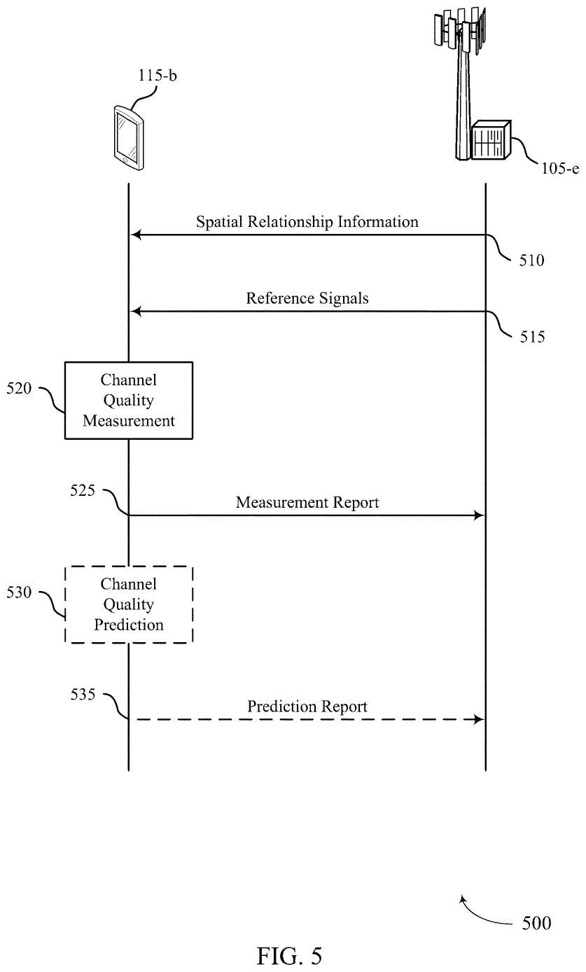

FIG. 5 shows an example of a process flow 500 that supports using beam neighboring information for beam prediction in accordance with one or more aspects of the present disclosure. The process flow 500 may implement aspects of the wireless communications system 100 and the wireless communications system 200 as described with reference to FIGS. 1 and 2. For instance, in the example of FIG. 5, a network entity 105-e may communicate with a UE 115-b. In the following description of the process flow 500, the operations between the UE 115-b and the network entity 105-e may be transmitted in a different order than the example order shown, or the operations between the UE 115-b and the network entity 105-e may be performed in different orders or at different times. Some operations may also be omitted from the process flow 500, and other operations may be added to the process flow 500.

At 510, the UE 115-b may receive a control message from the network entity 105-e indicating spatial relationship information associated with one or more resource pairs. The spatial relationship information may indicate a first resource pair of the one or more resource pairs that includes a first resource associated with a first cell and a second resource associated with a second cell that is different from the first cell. For example, the first resource may correspond to a first beam of the first cell and the second resource may correspond to a second beam of the second cell. In some examples, the network entity 105-e may indicate the spatial relationship information via a matrix associated with the one or more resource pairs for the channel quality measurement procedure, where the matrix may include a set of elements that indicate a spatial relationship between the first resource and the second resource. Additionally, or alternatively, the network entity 105-e may indicate probability information associated with the first resource pair for the channel quality measurement procedure, where the probability information may indicate the spatial relationship between the first resource and the second resource.

At 515, the UE 115-b may receive one or more reference signals via the first resource, the second resource, or both, based on the control message. The reference signals may be for a channel quality measurement procedure.

At 520, the UE 115-b may perform a channel quality measurement procedure for the one or more reference signals based on the first resource associated with the first cell and the second resource associated with the second cell. In some examples, the channel quality measurement procedure may include measuring channel characteristics such as L1-RSRPs, L1-SINR, and the like.

At 525, the UE 115-b may transmit, based on the channel quality measurement procedure, a report that indicates a first channel quality measurement for the first resource pair and a set of identifiers that corresponds to the first resource pair. The report may be based on a payload size indicated via the control message. In some examples, the report may include a second channel quality measurement for a second resource pair.

At 530, the UE 115-b may perform a channel quality prediction procedure for the one or more reference signals based at least in part on a third resource associated with the first cell and a fourth resource associated with the second cell. In some examples, the third resource and the fourth resource may be indicated via the control message and may be different from the first resource and the second resource. In some cases, the third and fourth resources may be a combination of CMRs and virtual resources.

At 535, the UE 115-b may transmit, based on the channel quality prediction procedure, a report that indicates a first channel quality prediction for the one or more reference signals.

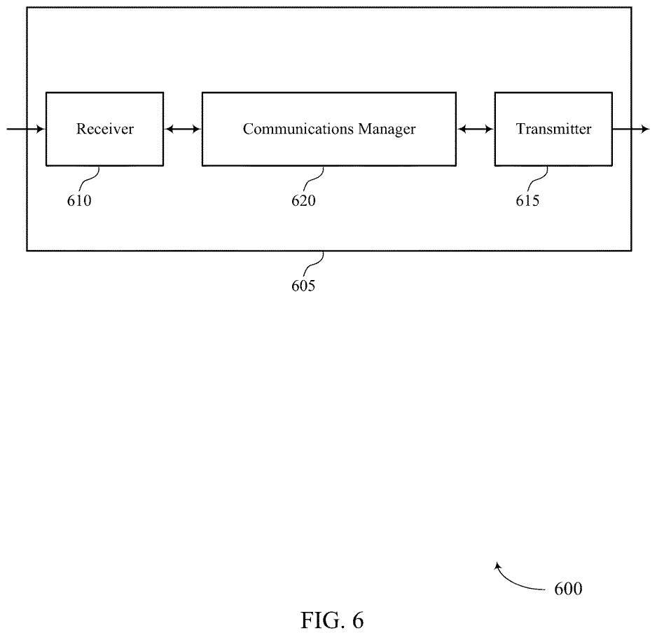

FIG. 6 shows a block diagram 600 of a device 605 that supports using beam neighboring information for beam prediction in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to using beam neighboring information for beam prediction).

Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to using beam neighboring information for beam prediction). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of using beam neighboring information for beam prediction as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 is capable of, configured to, or operable to support a means for receiving a control message that indicates spatial relationship information associated with one or more resource pairs, the spatial relationship information indicating a first resource pair of the one or more resource pairs that includes a first resource associated with a first cell and a second resource associated with a second cell different from the first cell, where the first resource corresponds to a first beam of the first cell and the second resource corresponds to a second beam of the second cell. The communications manager 620 is capable of, configured to, or operable to support a means for receiving one or more reference signals via the first resource, the second resource, or both, based on the control message. The communications manager 620 is capable of, configured to, or operable to support a means for performing a channel quality measurement procedure for the one or more reference signals based on the first resource associated with the first cell and the second resource associated with the second cell.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced overhead and more efficient utilization of communication resources.

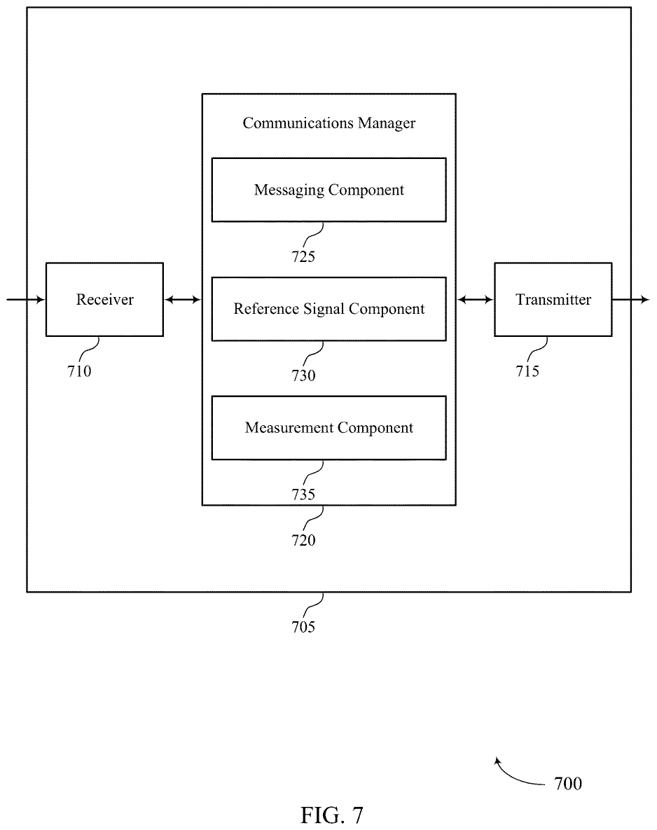

FIG. 7 shows a block diagram 700 of a device 705 that supports using beam neighboring information for beam prediction in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to using beam neighboring information for beam prediction).

Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to using beam neighboring information for beam prediction). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of using beam neighboring information for beam prediction as described herein. For example, the communications manager 720 may include a messaging component 725, a reference signal component 730, a measurement component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The messaging component 725 is capable of, configured to, or operable to support a means for receiving a control message that indicates spatial relationship information associated with one or more resource pairs, the spatial relationship information indicating a first resource pair of the one or more resource pairs that includes a first resource associated with a first cell and a second resource associated with a second cell different from the first cell, where the first resource corresponds to a first beam of the first cell and the second resource corresponds to a second beam of the second cell. The reference signal component 730 is capable of, configured to, or operable to support a means for receiving one or more reference signals via the first resource, the second resource, or both, based on the control message. The measurement component 735 is capable of, configured to, or operable to support a means for performing a channel quality measurement procedure for the one or more reference signals based on the first resource associated with the first cell and the second resource associated with the second cell.

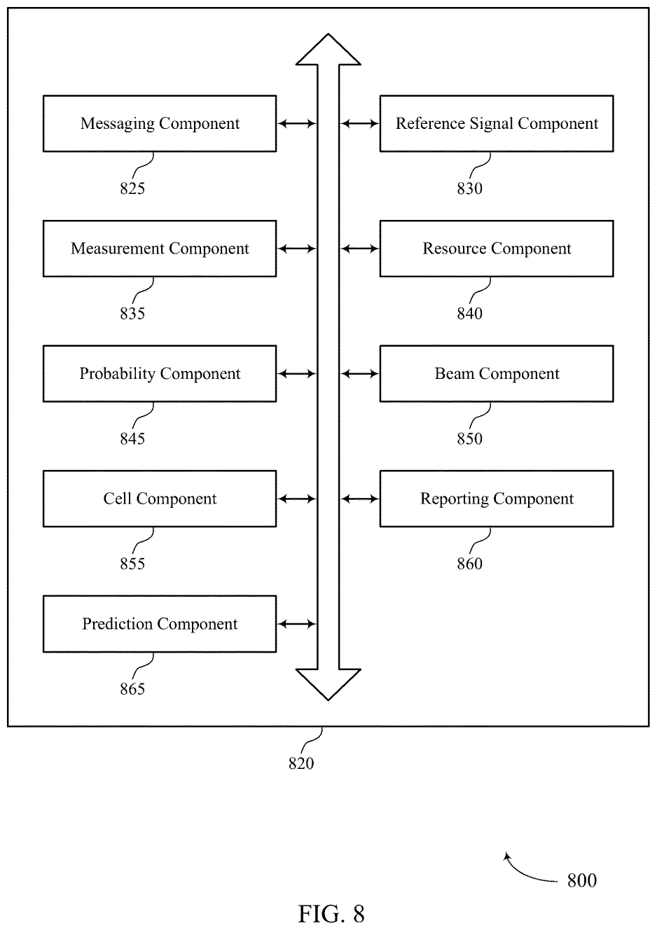

FIG. 8 shows a block diagram 800 of a communications manager 820 that supports using beam neighboring information for beam prediction in accordance with one or more aspects of the present disclosure. The communications manager 820 may be an example of aspects of a communications manager 620, a communications manager 720, or both, as described herein. The communications manager 820, or various components thereof, may be an example of means for performing various aspects of using beam neighboring information for beam prediction as described herein. For example, the communications manager 820 may include a messaging component 825, a reference signal component 830, a measurement component 835, a resource component 840, a probability component 845, a beam component 850, a cell component 855, a reporting component 860, a prediction component 865, or any combination thereof. Each of these components may communicate, directly or indirectly, with one another (e.g., via one or more buses).

The communications manager 820 may support wireless communication at a UE in accordance with examples as disclosed herein. The messaging component 825 is capable of, configured to, or operable to support a means for receiving a control message that indicates spatial relationship information associated with one or more resource pairs, the spatial relationship information indicating a first resource pair of the one or more resource pairs that includes a first resource associated with a first cell and a second resource associated with a second cell different from the first cell, where the first resource corresponds to a first beam of the first cell and the second resource corresponds to a second beam of the second cell. The reference signal component 830 is capable of, configured to, or operable to support a means for receiving one or more reference signals via the first resource, the second resource, or both, based on the control message. The measurement component 835 is capable of, configured to, or operable to support a means for performing a channel quality measurement procedure for the one or more reference signals based on the first resource associated with the first cell and the second resource associated with the second cell.

In some examples, to support receiving the control message, the resource component 840 is capable of, configured to, or operable to support a means for receiving a matrix associated with the one or more resource pairs for the channel quality measurement procedure, where the matrix includes a set of elements that indicate a spatial relationship between the first resource and the second resource.

In some examples, to support receiving the control message, the probability component 845 is capable of, configured to, or operable to support a means for receiving an indication of probability information associated with the first resource pair for the channel quality measurement procedure, the probability information indicating a spatial relationship between the first resource and the second resource.

In some examples, to support receiving the control message, the messaging component 825 is capable of, configured to, or operable to support a means for receiving a radio resource control message that indicates a first set of reference signal resources for the first cell and a second set of reference signal resources for the second cell, where the second set of reference signal resources are indicated based on a set of identifiers that correspond to one or more of the first set of reference signal resources.

In some examples, to support receiving the control message, the messaging component 825 is capable of, configured to, or operable to support a means for receiving a radio resource control message that indicates a channel state information report setting, where the channel state information report setting indicates the first resource pair based on a set of identifiers that correspond to the first cell and the second cell.

In some examples, to support receiving the control message, the messaging component 825 is capable of, configured to, or operable to support a means for receiving a radio resource control message that indicates a channel state information resource setting or a channel state information prediction resource setting, where the channel state information resource setting or the channel state information prediction resource setting indicates the one or more resource pairs based on a set of identifiers that correspond to a resource set.

In some examples, to support receiving the control message, the messaging component 825 is capable of, configured to, or operable to support a means for receiving a MAC-CE or DCI that activates a channel state information resource set or a channel state information report that indicates the one or more resource pairs.

In some examples, to support receiving the control message, the beam component 850 is capable of, configured to, or operable to support a means for receiving an indication of one or more beam pairs associated with the one or more resource pairs and an indication of probability information corresponding to a first beam pair of the one or more beam pairs, where the first beam pair includes the first beam and the second beam, and where the probability information indicates a spatial relationship between the first beam and the second beam.

In some examples, to support receiving the control message, the cell component 855 is capable of, configured to, or operable to support a means for receiving an indication of one or more cell pairs associated with the one or more resource pairs and an indication of probability information corresponding to a first cell pair of the one or more cell pairs, where the first cell pair includes the first cell the second cell, and where the probability information indicates a spatial relationship between the first cell and the second cell.

In some examples, the reporting component 860 is capable of, configured to, or operable to support a means for transmitting, based on the channel quality measurement procedure, a report that indicates a first channel quality measurement for the first resource pair and a set of identifiers that corresponds to the first resource pair.

In some examples, the report indicates the first channel quality measurement in accordance with a payload size for the report, where the payload size is indicated via the control message. In some examples, the report indicates a second channel quality measurement for a second resource pair of the one or more resource pairs and a second set of identifiers that corresponds to the second resource pair.

In some examples, the report indicates the first channel quality measurement in accordance with a first payload size for the report and the second channel quality measurement in accordance with a second payload size for the report, where the first payload size is indicated via the control message and the second payload size is based on the set of identifiers.

In some examples, the prediction component 865 is capable of, configured to, or operable to support a means for performing a channel quality prediction procedure for the one or more reference signals based on a third resource associated with the first cell and a fourth resource associated with the second cell, where the third resource and the fourth resource are indicated via the control message and are different from the first resource and the second resource. In some examples, the reporting component 860 is capable of, configured to, or operable to support a means for transmitting, based on the channel quality prediction procedure, a report that indicates a first channel quality prediction for the one or more reference signals.

In some examples, the first cell is a first layer 1/layer 2-triggered mobility (LTM) candidate cell and the second cell is a second LTM candidate cell, and where the first LTM candidate cell and the second LTM candidate cell are each associated with a respective serving cell or a respective non-serving cell.

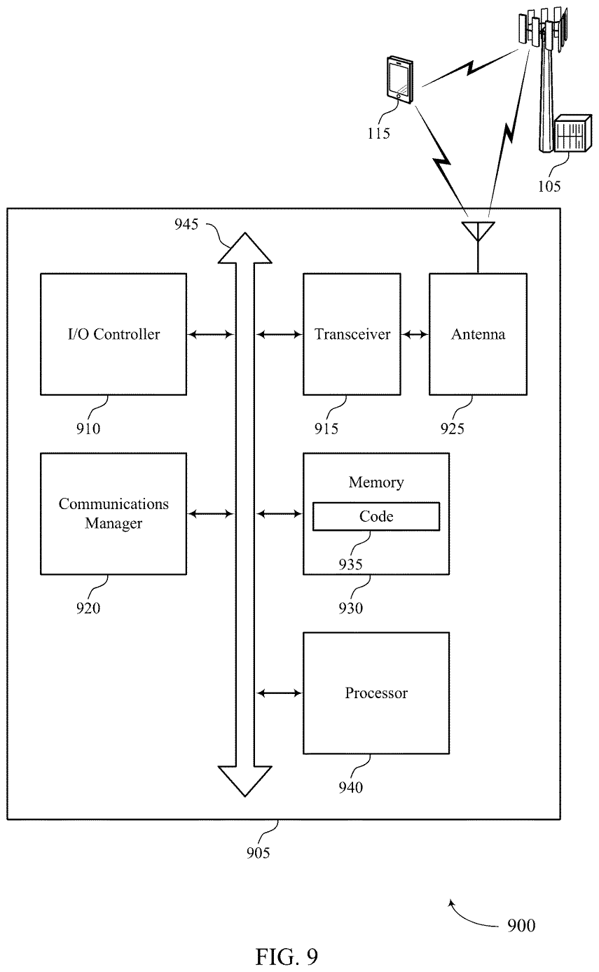

FIG. 9 shows a diagram of a system 900 including a device 905 that supports using beam neighboring information for beam prediction in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting using beam neighboring information for beam prediction). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 is capable of, configured to, or operable to support a means for receiving a control message that indicates spatial relationship information associated with one or more resource pairs, the spatial relationship information indicating a first resource pair of the one or more resource pairs that includes a first resource associated with a first cell and a second resource associated with a second cell different from the first cell, where the first resource corresponds to a first beam of the first cell and the second resource corresponds to a second beam of the second cell. The communications manager 920 is capable of, configured to, or operable to support a means for receiving one or more reference signals via the first resource, the second resource, or both, based on the control message. The communications manager 920 is capable of, configured to, or operable to support a means for performing a channel quality measurement procedure for the one or more reference signals based on the first resource associated with the first cell and the second resource associated with the second cell.

By including or configuring the communications manager 920 in accordance with examples as described herein, the device 905 may support techniques for reduced overhead, improved coordination between devices, and more efficient utilization of communication resources.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of using beam neighboring information for beam prediction as described herein, or the processor 940 and the memory 930 may be otherwise configured to perform or support such operations.

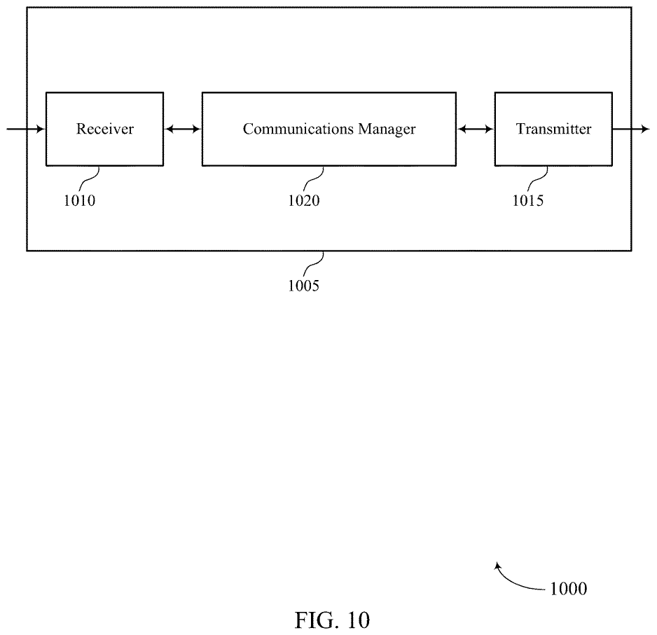

FIG. 10 shows a block diagram 1000 of a device 1005 that supports using beam neighboring information for beam prediction in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of using beam neighboring information for beam prediction as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communication at a network entity in accordance with examples as disclosed herein. For example, the communications manager 1020 is capable of, configured to, or operable to support a means for transmitting a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell. The communications manager 1020 is capable of, configured to, or operable to support a means for transmitting one or more reference signals via the first resource, the second resource, or both based on the control message.

Additionally, or alternatively, the communications manager 1020 may support wireless communication at a network entity in accordance with examples as disclosed herein. For example, the communications manager 1020 is capable of, configured to, or operable to support a means for receiving, from a core network, a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell. The communications manager 1020 is capable of, configured to, or operable to support a means for receiving one or more reference signals via the first resource, the second resource, or both based on the control message. The communications manager 1020 is capable of, configured to, or operable to support a means for performing a channel quality measurement procedure for the one or more reference signals based on the first resource associated with the first cell and the second resource associated with the second cell.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced overhead and more efficient utilization of communication resources.

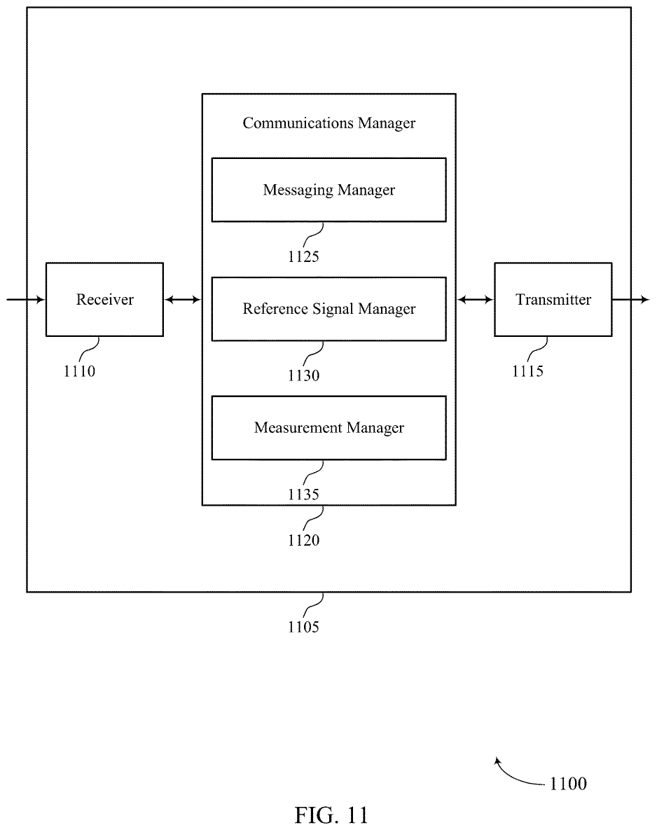

FIG. 11 shows a block diagram 1100 of a device 1105 that supports using beam neighboring information for beam prediction in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas.

Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of using beam neighboring information for beam prediction as described herein. For example, the communications manager 1120 may include a messaging manager 1125, a reference signal manager 1130, a measurement manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication at a network entity in accordance with examples as disclosed herein. The messaging manager 1125 is capable of, configured to, or operable to support a means for transmitting a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell. The reference signal manager 1130 is capable of, configured to, or operable to support a means for transmitting one or more reference signals via the first resource, the second resource, or both based on the control message.

Additionally, or alternatively, the communications manager 1120 may support wireless communication at a network entity in accordance with examples as disclosed herein. The messaging manager 1125 is capable of, configured to, or operable to support a means for receiving, from a core network, a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell. The reference signal manager 1130 is capable of, configured to, or operable to support a means for receiving one or more reference signals via the first resource, the second resource, or both based on the control message. The measurement manager 1135 is capable of, configured to, or operable to support a means for performing a channel quality measurement procedure for the one or more reference signals based on the first resource associated with the first cell and the second resource associated with the second cell.

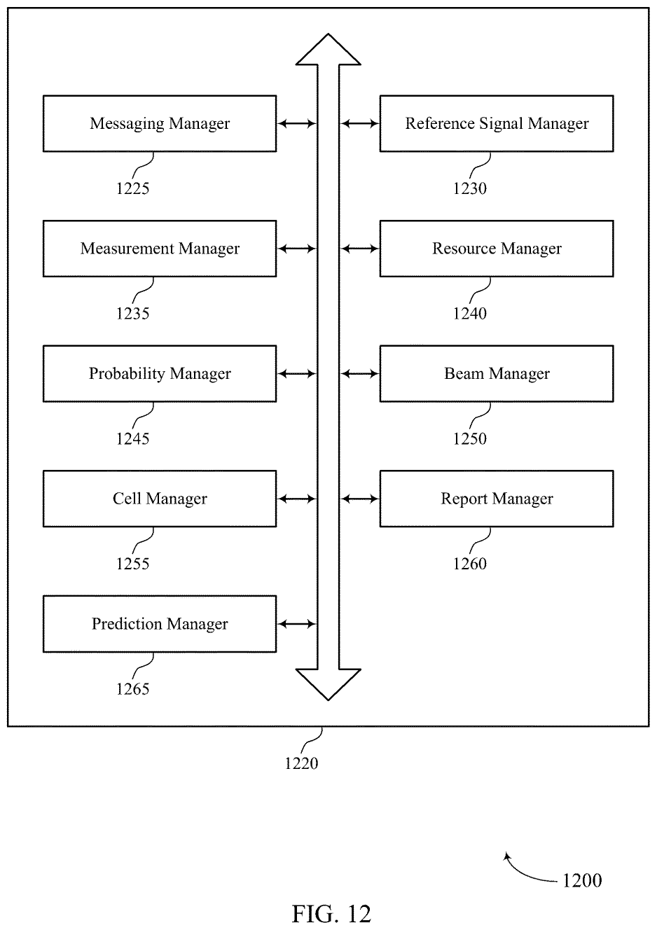

FIG. 12 shows a block diagram 1200 of a communications manager 1220 that supports using beam neighboring information for beam prediction in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of using beam neighboring information for beam prediction as described herein. For example, the communications manager 1220 may include a messaging manager 1225, a reference signal manager 1230, a measurement manager 1235, a resource manager 1240, a probability manager 1245, a beam manager 1250, a cell manager 1255, a report manager 1260, a prediction manager 1265, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communication at a network entity in accordance with examples as disclosed herein. The messaging manager 1225 is capable of, configured to, or operable to support a means for transmitting a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell. The reference signal manager 1230 is capable of, configured to, or operable to support a means for transmitting one or more reference signals via the first resource, the second resource, or both based on the control message.

In some examples, to support transmitting the control message, the resource manager 1240 is capable of, configured to, or operable to support a means for transmitting a matrix associated with the one or more resource pairs for a channel quality measurement procedure, where the matrix includes a set of elements that indicate a spatial relationship between the first resource and the second resource.

In some examples, to support transmitting the control message, the probability manager 1245 is capable of, configured to, or operable to support a means for transmitting an indication of probability information associated with the first resource pair for a channel quality measurement procedure, the probability information indicating a spatial relationship between the first resource and the second resource.

In some examples, to support transmitting the control message, the beam manager 1250 is capable of, configured to, or operable to support a means for transmitting an indication of one or more beam pairs associated with the one or more resource pairs and an indication of probability information corresponding to a first beam pair of the one or more beam pairs, where the first beam pair includes the first beam and the second beam, and where the probability information indicates a spatial relationship between the first beam and the second beam.

In some examples, to support transmitting the control message, the cell manager 1255 is capable of, configured to, or operable to support a means for transmitting an indication of one or more cell pairs associated with the one or more resource pairs and an indication of probability information corresponding to a first cell pair of the one or more cell pairs, where the first cell pair includes the first cell the second cell, and where the probability information indicates a spatial relationship between the first cell and the second cell.

In some examples, the report manager 1260 is capable of, configured to, or operable to support a means for receiving a report that indicates a first channel quality measurement for the first resource pair and a set of identifiers that corresponds to the first resource pair.

In some examples, the report indicates a second channel quality measurement for a second resource pair of the one or more resource pairs and a second set of identifiers that corresponds to the second resource pair.

In some examples, the first cell is a first layer 1/layer 2-triggered mobility (LTM) candidate cell and the second cell is a second LTM candidate cell, and where the first LTM candidate cell and the second LTM candidate cell are each associated with a respective serving cell or a respective non-serving cell.

Additionally, or alternatively, the communications manager 1220 may support wireless communication at a network entity in accordance with examples as disclosed herein. In some examples, the messaging manager 1225 is capable of, configured to, or operable to support a means for receiving, from a core network, a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell. In some examples, the reference signal manager 1230 is capable of, configured to, or operable to support a means for receiving one or more reference signals via the first resource, the second resource, or both based on the control message. The measurement manager 1235 is capable of, configured to, or operable to support a means for performing a channel quality measurement procedure for the one or more reference signals based on the first resource associated with the first cell and the second resource associated with the second cell.

In some examples, to support transmitting the control message, the messaging manager 1225 is capable of, configured to, or operable to support a means for transmitting a matrix associated with the one or more resource pairs for the channel quality measurement procedure, where the matrix includes a set of elements that indicate a spatial relationship between the first resource and the second resource.

In some examples, to support transmitting the control message, the probability manager 1245 is capable of, configured to, or operable to support a means for transmitting an indication of probability information associated with the first resource pair for the channel quality measurement procedure, the probability information indicating a spatial relationship between the first resource and the second resource.

In some examples, to support transmitting the control message, the beam manager 1250 is capable of, configured to, or operable to support a means for transmitting an indication of one or more beam pairs associated with the one or more resource pairs and an indication of probability information corresponding to a first beam pair of the one or more beam pairs, where the first beam pair includes the first beam and the second beam, and where the probability information indicates a spatial relationship between the first beam and the second beam.

In some examples, to support transmitting the control message, the cell manager 1255 is capable of, configured to, or operable to support a means for transmitting an indication of one or more cell pairs associated with the one or more resource pairs and an indication of probability information corresponding to a first cell pair of the one or more cell pairs, where the first cell pair includes the first cell the second cell, and where the probability information indicates a spatial relationship between the first cell and the second cell.

In some examples, the report manager 1260 is capable of, configured to, or operable to support a means for transmitting, based on the channel quality measurement procedure, a report that indicates a first channel quality measurement for the first resource pair and a set of identifiers that corresponds to the first resource pair.

In some examples, the report indicates a second channel quality measurement for a second resource pair of the one or more resource pairs and a second set of identifiers that corresponds to the second resource pair.

In some examples, the prediction manager 1265 is capable of, configured to, or operable to support a means for performing a channel quality prediction procedure for the one or more reference signals based on a third resource associated with the first cell and a fourth resource associated with the second cell, where the third resource and the fourth resource are indicated via the control message. In some examples, the report manager 1260 is capable of, configured to, or operable to support a means for transmitting, based on the channel quality prediction procedure, a report that indicates a first channel quality prediction for the one or more reference signals.

In some examples, the first cell is a first layer 1/layer 2-triggered mobility (LTM) candidate cell and the second cell is a second LTM candidate cell, and where the first LTM candidate cell and the second LTM candidate cell are each associated with a respective serving cell or a respective non-serving cell.

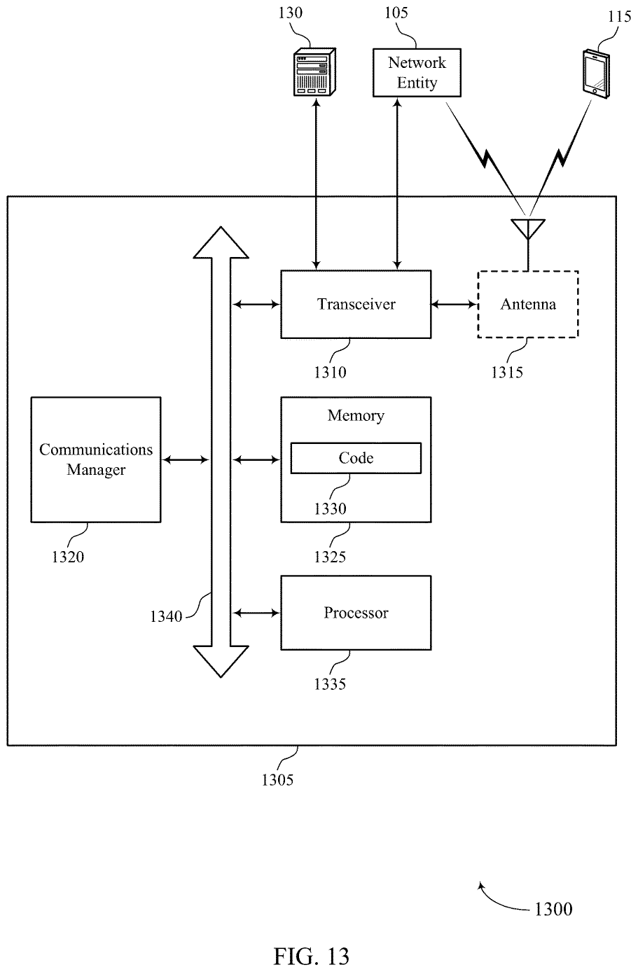

FIG. 13 shows a diagram of a system 1300 including a device 1305 that supports using beam neighboring information for beam prediction in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting using beam neighboring information for beam prediction). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communication at a network entity in accordance with examples as disclosed herein. For example, the communications manager 1320 is capable of, configured to, or operable to support a means for transmitting a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell. The communications manager 1320 is capable of, configured to, or operable to support a means for transmitting one or more reference signals via the first resource, the second resource, or both based on the control message.

Additionally, or alternatively, the communications manager 1320 may support wireless communication at a network entity in accordance with examples as disclosed herein. For example, the communications manager 1320 is capable of, configured to, or operable to support a means for receiving, from a core network, a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell. The communications manager 1320 is capable of, configured to, or operable to support a means for receiving one or more reference signals via the first resource, the second resource, or both based on the control message. The communications manager 1320 is capable of, configured to, or operable to support a means for performing a channel quality measurement procedure for the one or more reference signals based on the first resource associated with the first cell and the second resource associated with the second cell.

By including or configuring the communications manager 1320 in accordance with examples as described herein, the device 1305 may support techniques for reduced overhead, improved coordination between devices, and more efficient utilization of communication resources.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of using beam neighboring information for beam prediction as described herein, or the processor 1335 and the memory 1325 may be otherwise configured to perform or support such operations.

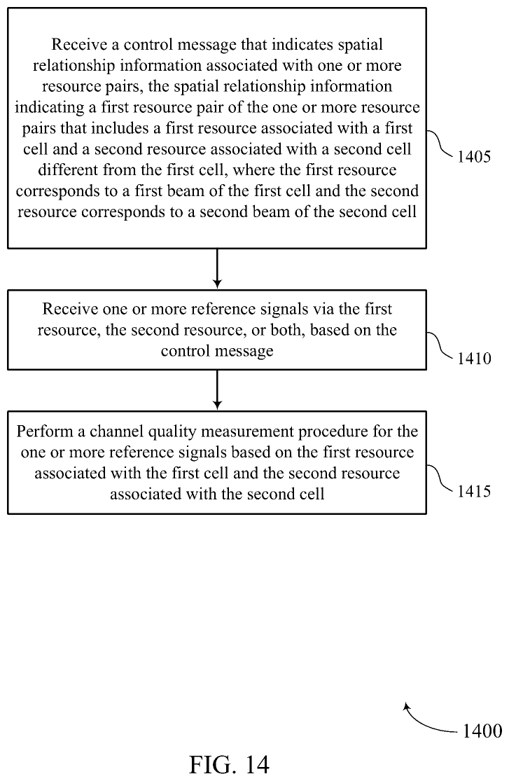

FIG. 14 shows a flowchart illustrating a method 1400 that supports using beam neighboring information for beam prediction in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1405, the method may include receiving a control message that indicates spatial relationship information associated with one or more resource pairs, the spatial relationship information indicating a first resource pair of the one or more resource pairs that includes a first resource associated with a first cell and a second resource associated with a second cell different from the first cell, where the first resource corresponds to a first beam of the first cell and the second resource corresponds to a second beam of the second cell. The operations of 1405 may be performed in accordance with examples as disclosed herein. In some examples, aspects of the operations of 1405 may be performed by a messaging component 825 as described with reference to FIG. 8.

At 1410, the method may include receiving one or more reference signals via the first resource, the second resource, or both, based on the control message. The operations of 1410 may be performed in accordance with examples as disclosed herein. In some examples, aspects of the operations of 1410 may be performed by a reference signal component 830 as described with reference to FIG. 8.

At 1415, the method may include performing a channel quality measurement procedure for the one or more reference signals based on the first resource associated with the first cell and the second resource associated with the second cell. The operations of 1415 may be performed in accordance with examples as disclosed herein. In some examples, aspects of the operations of 1415 may be performed by a measurement component 835 as described with reference to FIG. 8.

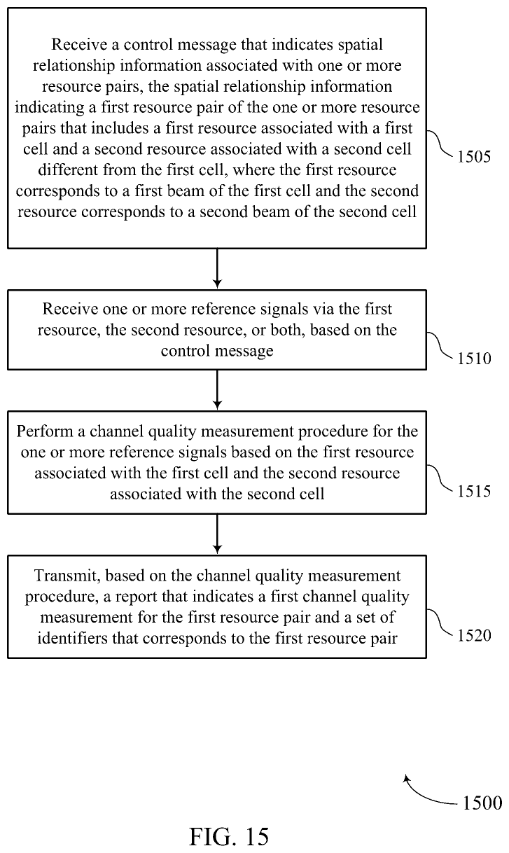

FIG. 15 shows a flowchart illustrating a method 1500 that supports using beam neighboring information for beam prediction in accordance with aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1505, the method may include receiving a control message that indicates spatial relationship information associated with one or more resource pairs, the spatial relationship information indicating a first resource pair of the one or more resource pairs that includes a first resource associated with a first cell and a second resource associated with a second cell different from the first cell, where the first resource corresponds to a first beam of the first cell and the second resource corresponds to a second beam of the second cell. The operations of 1505 may be performed in accordance with examples as disclosed herein. In some examples, aspects of the operations of 1505 may be performed by a messaging component 825 as described with reference to FIG. 8.

At 1510, the method may include receiving one or more reference signals via the first resource, the second resource, or both, based on the control message. The operations of 1510 may be performed in accordance with examples as disclosed herein. In some examples, aspects of the operations of 1510 may be performed by a reference signal component 830 as described with reference to FIG. 8.

At 1515, the method may include performing a channel quality measurement procedure for the one or more reference signals based on the first resource associated with the first cell and the second resource associated with the second cell. The operations of 1515 may be performed in accordance with examples as disclosed herein. In some examples, aspects of the operations of 1515 may be performed by a measurement component 835 as described with reference to FIG. 8.

At 1520, the method may include transmitting, based on the channel quality measurement procedure, a report that indicates a first channel quality measurement for the first resource pair and a set of identifiers that corresponds to the first resource pair. The operations of 1520 may be performed in accordance with examples as disclosed herein. In some examples, aspects of the operations of 1520 may be performed by a reporting component 860 as described with reference to FIG. 8.

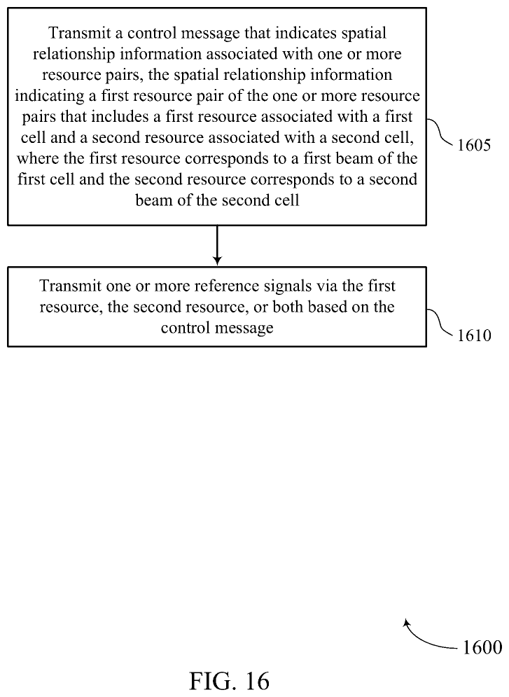

FIG. 16 shows a flowchart illustrating a method 1600 that supports using beam neighboring information for beam prediction in accordance with aspects of the present disclosure. The operations of the method 1600 may be implemented by a network entity or its components as described herein. For example, the operations of the method 1600 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1605, the method may include transmitting a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell. The operations of 1605 may be performed in accordance with examples as disclosed herein. In some examples, aspects of the operations of 1605 may be performed by a messaging manager 1225 as described with reference to FIG. 12.

At 1610, the method may include transmitting one or more reference signals via the first resource, the second resource, or both based on the control message. The operations of 1610 may be performed in accordance with examples as disclosed herein. In some examples, aspects of the operations of 1610 may be performed by a reference signal manager 1230 as described with reference to FIG. 12.

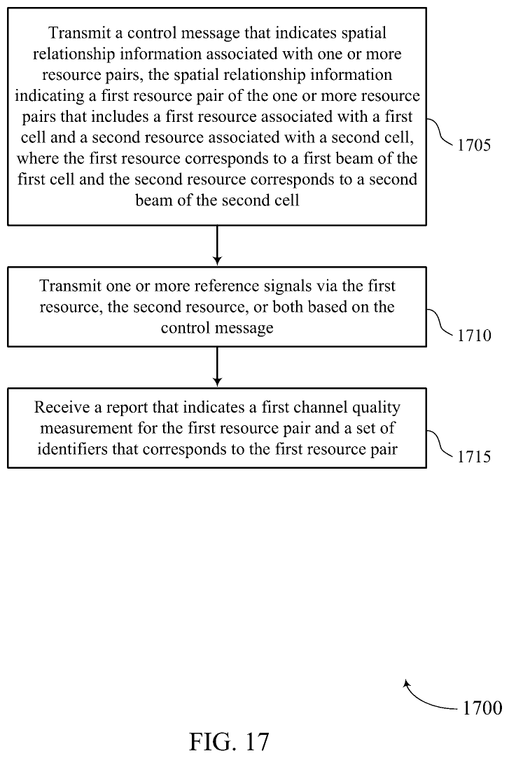

FIG. 17 shows a flowchart illustrating a method 1700 that supports using beam neighboring information for beam prediction in accordance with aspects of the present disclosure. The operations of the method 1700 may be implemented by a network entity or its components as described herein. For example, the operations of the method 1700 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1705, the method may include transmitting a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell. The operations of 1705 may be performed in accordance with examples as disclosed herein. In some examples, aspects of the operations of 1705 may be performed by a messaging manager 1225 as described with reference to FIG. 12.

At 1710, the method may include transmitting one or more reference signals via the first resource, the second resource, or both based on the control message. The operations of 1710 may be performed in accordance with examples as disclosed herein. In some examples, aspects of the operations of 1710 may be performed by a reference signal manager 1230 as described with reference to FIG. 12.

At 1715, the method may include receiving a report that indicates a first channel quality measurement for the first resource pair and a set of identifiers that corresponds to the first resource pair. The operations of 1715 may be performed in accordance with examples as disclosed herein. In some examples, aspects of the operations of 1715 may be performed by a report manager 1260 as described with reference to FIG. 12.

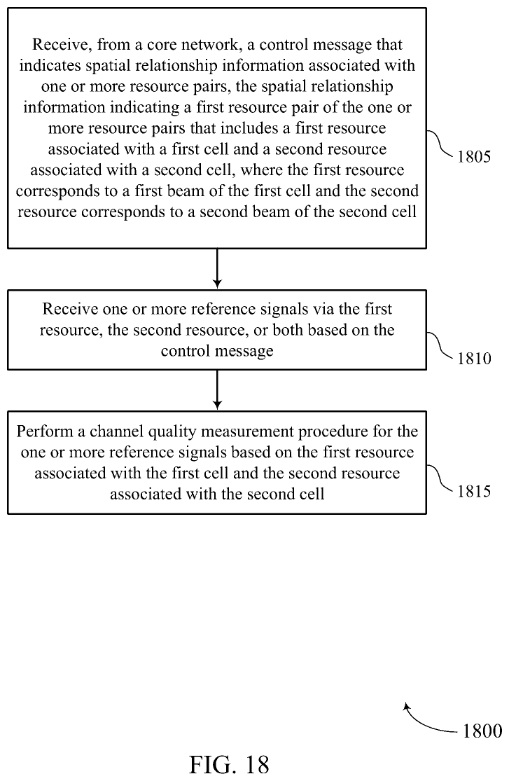

FIG. 18 shows a flowchart illustrating a method 1800 that supports using beam neighboring information for beam prediction in accordance with aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1805, the method may include receiving, from a core network, a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell. The operations of 1805 may be performed in accordance with examples as disclosed herein. In some examples, aspects of the operations of 1805 may be performed by a messaging manager 1225 as described with reference to FIG. 12.

At 1810, the method may include receiving one or more reference signals via the first resource, the second resource, or both based on the control message. The operations of 1810 may be performed in accordance with examples as disclosed herein. In some examples, aspects of the operations of 1810 may be performed by a reference signal manager 1230 as described with reference to FIG. 12.

At 1815, the method may include performing a channel quality measurement procedure for the one or more reference signals based on the first resource associated with the first cell and the second resource associated with the second cell. The operations of 1815 may be performed in accordance with examples as disclosed herein. In some examples, aspects of the operations of 1815 may be performed by a measurement manager 1235 as described with reference to FIG. 12.

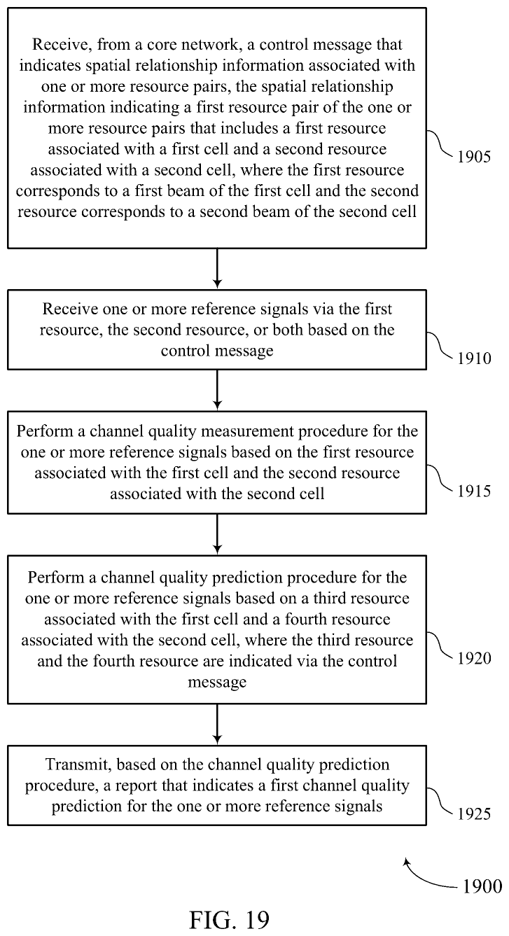

FIG. 19 shows a flowchart illustrating a method 1900 that supports using beam neighboring information for beam prediction in accordance with aspects of the present disclosure. The operations of the method 1900 may be implemented by a network entity or its components as described herein. For example, the operations of the method 1900 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1905, the method may include receiving, from a core network, a control message that indicates spatial relationship information associated with one or more resource pairs, the spatial relationship information indicating a first resource pair of the one or more resource pairs that includes a first resource associated with a first cell and a second resource associated with a second cell, where the first resource corresponds to a first beam of the first cell and the second resource corresponds to a second beam of the second cell. The operations of 1905 may be performed in accordance with examples as disclosed herein. In some examples, aspects of the operations of 1905 may be performed by a messaging manager 1225 as described with reference to FIG. 12.

At 1910, the method may include receiving one or more reference signals via the first resource, the second resource, or both based on the control message. The operations of 1910 may be performed in accordance with examples as disclosed herein. In some examples, aspects of the operations of 1910 may be performed by a reference signal manager 1230 as described with reference to FIG. 12.

At 1915, the method may include performing a channel quality measurement procedure for the one or more reference signals based on the first resource associated with the first cell and the second resource associated with the second cell. The operations of 1915 may be performed in accordance with examples as disclosed herein. In some examples, aspects of the operations of 1915 may be performed by a measurement manager 1235 as described with reference to FIG. 12.

At 1920, the method may include performing a channel quality prediction procedure for the one or more reference signals based on a third resource associated with the first cell and a fourth resource associated with the second cell, where the third resource and the fourth resource are indicated via the control message. The operations of 1920 may be performed in accordance with examples as disclosed herein. In some examples, aspects of the operations of 1920 may be performed by a prediction manager 1265 as described with reference to FIG. 12.

At 1925, the method may include transmitting, based on the channel quality prediction procedure, a report that indicates a first channel quality prediction for the one or more reference signals. The operations of 1925 may be performed in accordance with examples as disclosed herein. In some examples, aspects of the operations of 1925 may be performed by a report manager 1260 as described with reference to FIG. 12.

The following provides an overview of aspects of the present disclosure:
Aspect 1: A method for wireless communication at a UE, comprising: receiving a control message that indicates spatial relationship information associated with one or more resource pairs, the spatial relationship information indicating a first resource pair of the one or more resource pairs that comprises a first resource associated with a first cell and a second resource associated with a second cell different from the first cell, wherein the first resource corresponds to a first beam of the first cell and the second resource corresponds to a second beam of the second cell; receiving one or more reference signals via the first resource, the second resource, or both, based at least in part on the control message; and performing a channel quality measurement procedure for the one or more reference signals based at least in part on the first resource associated with the first cell and the second resource associated with the second cell.
Aspect 2: The method of aspect 1, wherein receiving the control message comprises: receiving a matrix associated with the one or more resource pairs for the channel quality measurement procedure, wherein the matrix comprises a set of elements that indicate a spatial relationship between the first resource and the second resource.
Aspect 3: The method of any of aspects 1 through 2, wherein receiving the control message comprises: receiving an indication of probability information associated with the first resource pair for the channel quality measurement procedure, the probability information indicating a spatial relationship between the first resource and the second resource.
Aspect 4: The method of any of aspects 1 through 3, wherein receiving the control message comprises: receiving a radio resource control message that indicates a first set of reference signal resources for the first cell and a second set of reference signal resources for the second cell, wherein the second set of reference signal resources are indicated based at least in part on a set of identifiers that correspond to one or more of the first set of reference signal resources.
Aspect 5: The method of any of aspects 1 through 4, wherein receiving the control message comprises: receiving a radio resource control message that indicates a channel state information report setting, wherein the channel state information report setting indicates the first resource pair based at least in part on a set of identifiers that correspond to the first cell and the second cell.
Aspect 6: The method of any of aspects 1 through 5, wherein receiving the control message comprises: receiving a radio resource control message that indicates a channel state information resource setting or a channel state information prediction resource setting, wherein the channel state information resource setting or the channel state information prediction resource setting indicates the one or more resource pairs based at least in part on a set of identifiers that correspond to a resource set.
Aspect 7: The method of any of aspects 1 through 6, wherein receiving the control message comprises: receiving a MAC-CE or DCI that activates a channel state information resource set or a channel state information report that indicates the one or more resource pairs.
Aspect 8: The method of any of aspects 1 through 7, wherein receiving the control message comprises: receiving an indication of one or more beam pairs associated with the one or more resource pairs and an indication of probability information corresponding to a first beam pair of the one or more beam pairs, wherein the first beam pair comprises the first beam and the second beam, and wherein the probability information indicates a spatial relationship between the first beam and the second beam.
Aspect 9: The method of any of aspects 1 through 8, wherein receiving the control message comprises: receiving an indication of one or more cell pairs associated with the one or more resource pairs and an indication of probability information corresponding to a first cell pair of the one or more cell pairs, wherein the first cell pair comprises the first cell the second cell, and wherein the probability information indicates a spatial relationship between the first cell and the second cell.
Aspect 10: The method of any of aspects 1 through 9, further comprising: transmitting, based at least in part on the channel quality measurement procedure, a report that indicates a first channel quality measurement for the first resource pair and a set of identifiers that corresponds to the first resource pair.
Aspect 11: The method of aspect 10, wherein the report indicates the first channel quality measurement in accordance with a payload size for the report, wherein the payload size is indicated via the control message.
Aspect 12: The method of any of aspects 10 through 11, wherein the report indicates a second channel quality measurement for a second resource pair of the one or more resource pairs and a second set of identifiers that corresponds to the second resource pair.
Aspect 13: The method of aspect 12, wherein the report indicates the first channel quality measurement in accordance with a first payload size for the report and the second channel quality measurement in accordance with a second payload size for the report, wherein the first payload size is indicated via the control message and the second payload size is based at least in part on the set of identifiers.
Aspect 14: The method of any of aspects 1 through 13, further comprising: performing a channel quality prediction procedure for the one or more reference signals based at least in part on a third resource associated with the first cell and a fourth resource associated with the second cell, wherein the third resource and the fourth resource are indicated via the control message and are different from the first resource and the second resource; and transmitting, based at least in part on the channel quality prediction procedure, a report that indicates a first channel quality prediction for the one or more reference signals.
Aspect 15: The method of any of aspects 1 through 14, wherein the first cell is a first LTM candidate cell and the second cell is a second LTM candidate cell, and wherein the first LTM candidate cell and the second LTM candidate cell are each associated with a respective serving cell or a respective non-serving cell.
Aspect 16: A method for wireless communication at a network entity, comprising: transmitting a control message that indicates spatial relationship information associated with one or more resource pairs, the spatial relationship information indicating a first resource pair of the one or more resource pairs that comprises a first resource associated with a first cell and a second resource associated with a second cell, wherein the first resource corresponds to a first beam of the first cell and the second resource corresponds to a second beam of the second cell; and transmitting one or more reference signals via the first resource, the second resource, or both based at least in part on the control message.
Aspect 17: The method of aspect 16, wherein transmitting the control message comprises: transmitting a matrix associated with the one or more resource pairs for a channel quality measurement procedure, wherein the matrix comprises a set of elements that indicate a spatial relationship between the first resource and the second resource.
Aspect 18: The method of any of aspects 16 through 17, wherein transmitting the control message comprises: transmitting an indication of probability information associated with the first resource pair for a channel quality measurement procedure, the probability information indicating a spatial relationship between the first resource and the second resource.
Aspect 19: The method of any of aspects 16 through 18, wherein transmitting the control message comprises: transmitting an indication of one or more beam pairs associated with the one or more resource pairs and an indication of probability information corresponding to a first beam pair of the one or more beam pairs, wherein the first beam pair comprises the first beam and the second beam, and wherein the probability information indicates a spatial relationship between the first beam and the second beam.
Aspect 20: The method of any of aspects 16 through 19, wherein transmitting the control message comprises: transmitting an indication of one or more cell pairs associated with the one or more resource pairs and an indication of probability information corresponding to a first cell pair of the one or more cell pairs, wherein the first cell pair comprises the first cell the second cell, and wherein the probability information indicates a spatial relationship between the first cell and the second cell.
Aspect 21: The method of any of aspects 16 through 20, further comprising: receiving a report that indicates a first channel quality measurement for the first resource pair and a set of identifiers that corresponds to the first resource pair.
Aspect 22: The method of aspect 21, wherein the report indicates a second channel quality measurement for a second resource pair of the one or more resource pairs and a second set of identifiers that corresponds to the second resource pair.
Aspect 23: The method of any of aspects 16 through 22, wherein the first cell is a first LTM candidate cell and the second cell is a second LTM candidate cell, and wherein the first LTM candidate cell and the second LTM candidate cell are each associated with a respective serving cell or a respective non-serving cell.
Aspect 24: A method for wireless communication at a network entity, comprising: receiving, from a core network, a control message that indicates spatial relationship information associated with one or more resource pairs, the spatial relationship information indicating a first resource pair of the one or more resource pairs that comprises a first resource associated with a first cell and a second resource associated with a second cell, wherein the first resource corresponds to a first beam of the first cell and the second resource corresponds to a second beam of the second cell; receiving one or more reference signals via the first resource, the second resource, or both based at least in part on the control message; and performing a channel quality measurement procedure for the one or more reference signals based at least in part on the first resource associated with the first cell and the second resource associated with the second cell.
Aspect 25: The method of aspect 24, wherein transmitting the control message comprises: transmitting a matrix associated with the one or more resource pairs for the channel quality measurement procedure, wherein the matrix comprises a set of elements that indicate a spatial relationship between the first resource and the second resource.
Aspect 26: The method of any of aspects 24 through 25, wherein transmitting the control message comprises: transmitting an indication of probability information associated with the first resource pair for the channel quality measurement procedure, the probability information indicating a spatial relationship between the first resource and the second resource.
Aspect 27: The method of any of aspects 24 through 26, wherein transmitting the control message comprises: transmitting an indication of one or more beam pairs associated with the one or more resource pairs and an indication of probability information corresponding to a first beam pair of the one or more beam pairs, wherein the first beam pair comprises the first beam and the second beam, and wherein the probability information indicates a spatial relationship between the first beam and the second beam.
Aspect 28: The method of any of aspects 24 through 27, wherein transmitting the control message comprises: transmitting an indication of one or more cell pairs associated with the one or more resource pairs and an indication of probability information corresponding to a first cell pair of the one or more cell pairs, wherein the first cell pair comprises the first cell the second cell, and wherein the probability information indicates a spatial relationship between the first cell and the second cell.
Aspect 29: The method of any of aspects 24 through 28, further comprising: transmitting, based at least in part on the channel quality measurement procedure, a report that indicates a first channel quality measurement for the first resource pair and a set of identifiers that corresponds to the first resource pair.
Aspect 30: The method of aspect 29, wherein the report indicates a second channel quality measurement for a second resource pair of the one or more resource pairs and a second set of identifiers that corresponds to the second resource pair.
Aspect 31: The method of any of aspects 24 through 30, further comprising: performing a channel quality prediction procedure for the one or more reference signals based at least in part on a third resource associated with the first cell and a fourth resource associated with the second cell, wherein the third resource and the fourth resource are indicated via the control message; and transmitting, based at least in part on the channel quality prediction procedure, a report that indicates a first channel quality prediction for the one or more reference signals.
Aspect 32: The method of any of aspects 24 through 31, wherein the first cell is a first LTM candidate cell and the second cell is a second LTM candidate cell, and wherein the first LTM candidate cell and the second LTM candidate cell are each associated with a respective serving cell or a respective non-serving cell.
Aspect 33: An apparatus for wireless communication at a UE, comprising a processor; memory coupled with the processor; and instructions stored in the memory and executable by the processor to cause the apparatus to perform a method of any of aspects 1 through 15.
Aspect 34: An apparatus for wireless communication at a UE, comprising at least one means for performing a method of any of aspects 1 through 15.
Aspect 35: A non-transitory computer-readable medium storing code for wireless communication at a UE, the code comprising instructions executable by a processor to perform a method of any of aspects 1 through 15.
Aspect 36: An apparatus for wireless communication at a network entity, comprising a processor; memory coupled with the processor; and instructions stored in the memory and executable by the processor to cause the apparatus to perform a method of any of aspects 16 through 23.
Aspect 37: An apparatus for wireless communication at a network entity, comprising at least one means for performing a method of any of aspects 16 through 23.
Aspect 38: A non-transitory computer-readable medium storing code for wireless communication at a network entity, the code comprising instructions executable by a processor to perform a method of any of aspects 16 through 23.
Aspect 39: An apparatus for wireless communication at a network entity, comprising a processor; memory coupled with the processor; and instructions stored in the memory and executable by the processor to cause the apparatus to perform a method of any of aspects 24 through 32.
Aspect 40: An apparatus for wireless communication at a network entity, comprising at least one means for performing a method of any of aspects 24 through 32.
Aspect 41: A non-transitory computer-readable medium storing code for wireless communication at a network entity, the code comprising instructions executable by a processor to perform a method of any of aspects 24 through 32.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers.

Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communication at a user equipment (UE), comprising:
a processor;
memory coupled with the processor; and
instructions stored in the memory and executable by the processor to cause the apparatus to:
receive a control message that indicates spatial relationship information associated with one or more resource pairs, the spatial relationship information indicating a first resource pair of the one or more resource pairs that comprises a first resource associated with a first cell and a second resource associated with a second cell different from the first cell, wherein the first resource corresponds to a first beam of the first cell and the second resource corresponds to a second beam of the second cell;
receive one or more reference signals via the first resource, the second resource, or both, based at least in part on the control message; and
perform a channel quality measurement procedure for the one or more reference signals based at least in part on the first resource associated with the first cell and the second resource associated with the second cell.

2. The apparatus of claim 1, wherein the instructions to receive the control message are executable by the processor to cause the apparatus to:
receive a matrix associated with the one or more resource pairs for the channel quality measurement procedure, wherein the matrix comprises a set of elements that indicate a spatial relationship between the first resource and the second resource.

3. The apparatus of claim 1, wherein the instructions to receive the control message are executable by the processor to cause the apparatus to:
receive an indication of probability information associated with the first resource pair for the channel quality measurement procedure, the probability information indicating a spatial relationship between the first resource and the second resource.

4-7. (canceled)

8. The apparatus of claim 1, wherein the instructions to receive the control message are executable by the processor to cause the apparatus to:
receive an indication of one or more beam pairs associated with the one or more resource pairs and an indication of probability information corresponding to a first beam pair of the one or more beam pairs, wherein the first beam pair comprises the first beam and the second beam, and wherein the probability information indicates a spatial relationship between the first beam and the second beam.

9. The apparatus of claim 1, wherein the instructions to receive the control message are executable by the processor to cause the apparatus to:
receive an indication of one or more cell pairs associated with the one or more resource pairs and an indication of probability information corresponding to a first cell pair of the one or more cell pairs, wherein the first cell pair comprises the first cell the second cell, and wherein the probability information indicates a spatial relationship between the first cell and the second cell.

10. The apparatus of claim 1, wherein the instructions are further executable by the processor to cause the apparatus to:
transmit, based at least in part on the channel quality measurement procedure, a report that indicates a first channel quality measurement for the first resource pair and a set of identifiers that corresponds to the first resource pair.

11. The apparatus of claim 10, wherein the report indicates the first channel quality measurement in accordance with a payload size for the report, wherein the payload size is indicated via the control message.

12. The apparatus of claim 10, wherein the report indicates a second channel quality measurement for a second resource pair of the one or more resource pairs and a second set of identifiers that corresponds to the second resource pair.

13. The apparatus of claim 12, wherein the report indicates the first channel quality measurement in accordance with a first payload size for the report and the second channel quality measurement in accordance with a second payload size for the report, wherein the first payload size is indicated via the control message and the second payload size is based at least in part on the set of identifiers.

14. The apparatus of claim 1, wherein the instructions are further executable by the processor to cause the apparatus to:
perform a channel quality prediction procedure for the one or more reference signals based at least in part on a third resource associated with the first cell and a fourth resource associated with the second cell, wherein the third resource and the fourth resource are indicated via the control message and are different from the first resource and the second resource; and
transmit, based at least in part on the channel quality prediction procedure, a report that indicates a first channel quality prediction for the one or more reference signals.

15. The apparatus of claim 1, wherein the first cell is a first layer 1/layer 2-triggered mobility (LTM) candidate cell and the second cell is a second LTM candidate cell, and wherein the first LTM candidate cell and the second LTM candidate cell are each associated with a respective serving cell or a respective non-serving cell.

16. An apparatus for wireless communication at a network entity, comprising:
a processor;
memory coupled with the processor; and
instructions stored in the memory and executable by the processor to cause the apparatus to:
transmit a control message that indicates spatial relationship information associated with one or more resource pairs, the spatial relationship information indicating a first resource pair of the one or more resource pairs that comprises a first resource associated with a first cell and a second resource associated with a second cell, wherein the first resource corresponds to a first beam of the first cell and the second resource corresponds to a second beam of the second cell; and
transmit one or more reference signals via the first resource, the second resource, or both based at least in part on the control message.

17. The apparatus of claim 16, wherein the instructions to transmit the control message are executable by the processor to cause the apparatus to:
transmit a matrix associated with the one or more resource pairs for a channel quality measurement procedure, wherein the matrix comprises a set of elements that indicate a spatial relationship between the first resource and the second resource.

18. The apparatus of claim 16, wherein the instructions to transmit the control message are executable by the processor to cause the apparatus to:
transmit an indication of probability information associated with the first resource pair for a channel quality measurement procedure, the probability information indicating a spatial relationship between the first resource and the second resource.

19. The apparatus of claim 16, wherein the instructions to transmit the control message are executable by the processor to cause the apparatus to:
transmit an indication of one or more beam pairs associated with the one or more resource pairs and an indication of probability information corresponding to a first beam pair of the one or more beam pairs, wherein the first beam pair comprises the first beam and the second beam, and wherein the probability information indicates a spatial relationship between the first beam and the second beam.

20. The apparatus of claim 16, wherein the instructions to transmit the control message are executable by the processor to cause the apparatus to:
transmit an indication of one or more cell pairs associated with the one or more resource pairs and an indication of probability information corresponding to a first cell pair of the one or more cell pairs, wherein the first cell pair comprises the first cell the second cell, and wherein the probability information indicates a spatial relationship between the first cell and the second cell.

21. The apparatus of claim 16, wherein the instructions are further executable by the processor to cause the apparatus to:
receive a report that indicates a first channel quality measurement for the first resource pair and a set of identifiers that corresponds to the first resource pair.

22. The apparatus of claim 21, wherein the report indicates a second channel quality measurement for a second resource pair of the one or more resource pairs and a second set of identifiers that corresponds to the second resource pair.

23. The apparatus of claim 16, wherein the first cell is a first layer 1/layer 2-triggered mobility (LTM) candidate cell and the second cell is a second LTM candidate cell, and wherein the first LTM candidate cell and the second LTM candidate cell are each associated with a respective serving cell or a respective non-serving cell.

24-29. (canceled)

30. A method for wireless communication at a user equipment (UE), comprising:
receiving a control message that indicates spatial relationship information associated with one or more resource pairs, the spatial relationship information indicating a first resource pair of the one or more resource pairs that comprises a first resource associated with a first cell and a second resource associated with a second cell different from the first cell, wherein the first resource corresponds to a first beam of the first cell and the second resource corresponds to a second beam of the second cell;
receiving one or more reference signals via the first resource, the second resource, or both, based at least in part on the control message; and
performing a channel quality measurement procedure for the one or more reference signals based at least in part on the first resource associated with the first cell and the second resource associated with the second cell.
